(19) United States
(12) Patent Application Publication
(10) Pub. No.: US 2005/0049369 A1
(43) Pub. Date: Mar. 3, 2005

(54) Method for preparing copolyestercarbonates

(75) Inventors: Gregory Allen O'Neil, Clifton Park, NY (US); Ali Ersin Acar, Clifton Park, NY (US); Paul Dean Sybert, Evansville, IN (US); Pratima Rangarajan, Clifton Park, NY (US); Hongyi Zhou, Niskayuna, NY (US); Joseph Anthony Suriano, Clifton Park, NY (US)

Correspondence Address: General Electric Company;CRD Patent Docket Rm 4A59, P.O. Box 8, Bldg. K-1, Schenectady, NY, 12301, US

(73) Assignee: General Electric Company

(21) Appl. No.: 10/639,998

(22) Filed: Aug. 12, 2003

(51) Int. Cl. C08F 20/00

(52) U.S. Cl. 525/439

(57) ABSTRACT

A method of preparing block copolyestercarbonates wherein at least one dihydroxy-substituted aromatic hydrocarbon moiety and at least one aromatic diacid chloride are reacted under interfacial conditions to give a hydroxy-terminated polyester intermediate. The dihydroxy-substituted aromatic compound is used in about 10 mole to about 125 mole percent excess relative to the diacid chloride. Enhanced control of hydroxy-terminated polyester intermediate molecular weight is achieved by limiting the amount of water present to provide a final salt level of greater than 30 percent. The final salt level is a theoretical value but is readily calculable. The hydroxy-terminated polyester intermediate is then converted to a block copolyestercarbonate by reaction with a carbonate precursor such as phosgene.

### BACKGROUND OF THE INVENTION

This invention relates to a method for preparing transparent, non- ghosting copolyestercarbonate compositions comprising at least one carbonate block and at least one polyester block with chain members derived from at least one dihydroxy-substituted aromatic hydrocarbon moiety and at least one aromatic dicarboxylic acid moiety (sometimes referred to hereinafter as arylate chain members). In a particular embodiment the invention relates to a method for preparing transparent, non-ghosting copolyestercarbonates comprising at least one carbonate block and at least one polyester block with chain members derived from at least one 1,3-dihydroxybenzene moiety and at least one aromatic dicarboxylic acid moiety (sometimes referred to hereinafter as resorcinol arylate chain members).

Notwithstanding the excellent physical properties of copolyestercarbonates and the utility of such copolymers as “weatherable” materials resistant to photodegradation, scratching, and attack by solvents, known copolyestercarbonates are limited by the inherent tendency of the polycarbonate and polyester blocks of the copolymer to phase separate. When the phase separation of the polycarbonate and polyester blocks of the copolyestercarbonate achieves a threshold level (i.e. the polyester and polycarbonate domains become large enough to produce an effect visible to the human eye) this phase separation behavior results in “haze” in molded articles and “ghosting” in films prepared from the copolyestercarbonate. Both “haze” and “ghosting” detract from the overall transparent appearance desired of a molded article or film. Copolyestercarbonates having higher polycarbonate content (20 weight percent or more polycarbonate blocks) are particularly susceptible to phase separation the polycarbonate and polyester blocks of the copolyestercarbonate at a level which produces optical effects visible to the human eye.

It would be highly desirable to be able to prepare block copolyestercarbonates having any level of polycarbonate content, and which were highly transparent and did not exhibit haze or ghosting. Thus, an effective method for limiting phase separation of the polycarbonate and polyester blocks in copolyestercarbonates to levels of phase separation not producing visible effects such as haze or ghosting in films and molded articles comprising such unique copolyestercarbonates has been keenly sought after. Current methods of copolyestercarbonate preparation provide only limited access to such transparent, non- ghosting copolyestercarbonate compositions.

The present invention provides a new method for the preparation of transparent copolysetercarbonates which effectively minimizes haze and ghosting in a wide range of copolyestercarbonate compositions and architectures.

### BRIEF SUMMARY OF THE INVENTION

In one aspect, the present invention provides a method of preparing block copolyestercarbonates comprising chain members derived from at least one dihydroxy-substituted aromatic hydrocarbon moiety and at least one aromatic dicarboxylic acid moiety, said method comprising the steps of:
(a) preparing a hydroxy-terminated polyester intermediate comprising structural units derived from at least one dihydroxy-substituted aromatic hydrocarbon moiety and at least one aromatic dicarboxylic acid moiety, by reacting under interfacial conditions at least one dihydroxy-substituted aromatic compound with at least one diacid chloride, said dihydroxy-substituted aromatic compound being present in an amount corresponding to from about 10 mole percent excess to about 125 mole percent excess relative to the amount of diacid chloride, said reacting under interfacial conditions comprising an amount of water corresponding to a final salt level of greater than 30 percent; and
(b) conducting a reaction of the hydroxy-terminated polyester intermediate with phosgene in a reaction mixture comprising water, a substantially water-immiscible organic solvent, and a base.

In another aspect, the present invention relates to a method of preparing hydroxy-terminated polyester intermediates comprising structural units derived from at least one dihydroxy-substituted aromatic hydrocarbon moiety and at least one aromatic dicarboxylic acid moiety.

### DETAILED DESCRIPTION OF THE INVENTION

The present invention may be understood more readily by reference to the following detailed description of preferred embodiments of the invention and the examples included herein. In this specification and in the claims which follow, reference will be made to a number of terms which shall be defined to have the following meanings.

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

“BPA” is herein defined as bisphenol A and is also known as 2,2-bis(4-hydroxyphenyl)propane, 4,4′-isopropylidenediphenol and p,p-BPA.

As noted, the present invention relates to a method for the preparation of copolyestercarbonates, materials useful for their physical properties, among them thermal stability and stability to ultraviolet radiation. In one embodiment the present invention comprises a method for preparing copolyestercarbonates comprising at least one carbonate block and at least one polyester block with chain members derived from at least one dihydroxy-substituted aromatic hydrocarbon moiety and at least one aromatic dicarboxylic acid moiety. In another embodiment the present invention comprises a method for preparing copolyestercarbonates comprising at least one carbonate block and at least one polyester block with chain members derived from at least one 1,3-dihydroxybenzene moiety and at least one aromatic dicarboxylic acid moiety.

In various embodiments the copolyestercarbonates of the present invention are transparent, non-ghosting materials which are thermally stable. Transparent within the context of the present invention means transparent to the human eye when the film is looked through at various angles of observation. Non-ghosting within the context of the present invention means that films prepared from the product copolyestercarbonates do not exhibit “ghosting”, that is the films are free of haziness apparent to the human eye when the film is looked through. Thermal stability within the context of the present invention refers to resistance of a polymer to molecular weight degradation under thermal conditions. Thus, a polymer with poor thermal stability shows significant molecular weight degradation under thermal conditions, such as during extrusion, molding, thermoforming, hot-pressing, and like conditions. Molecular weight degradation may also be manifested through color formation and/or in the degradation of other properties such as weatherability, gloss, mechanical properties, and/or thermal properties. Molecular weight degradation can also cause significant variation in processing conditions as the melt viscosity of the polymer changes.

In one of its aspects the method of the present invention provides transparent, non-ghosting, thermally stable copolyestercarbonates comprising arylate polyester chain members. Said chain members comprise at least one dihydroxy-substituted aromatic hydrocarbon moiety in combination with at least one aromatic dicarboxylic acid moiety. In one particular embodiment the dihydroxy-substituted aromatic hydrocarbon moiety is derived from a 1,3-dihydroxybenzene moiety, illustrated in the structural moiety of formula (I), commonly referred to throughout this specification as resorcinol or resorcinol moiety. In formula (I) R is at least one of C₁₋₁₂ alkyl or halogen, and n is 0-3. Resorcinol or resorcinol moiety as used within the context of the present invention should be understood to include both unsubstituted 1,3-dihydroxybenzene and substituted 1,3-dihydroxybenzenes unless explicitly stated otherwise.

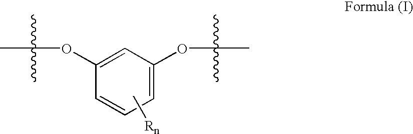

Suitable dicarboxylic acid residues include aromatic dicarboxylic acid residues derived from monocyclic moieties, including isophthalic acid, terephthalic acid, or mixtures of isophthalic and terephthalic acids, or from polycyclic moieties. In various embodiments the aromatic dicarboxylic acid residues are derived from mixtures of isophthalic and terephthalic acids as typically illustrated in the structural moiety of formula (II).

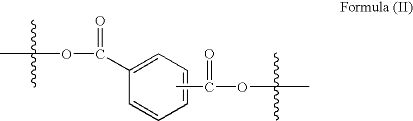

Therefore, in one particular embodiment the present invention provides transparent, non-ghosting, thermally stable copolyestercarbonates comprising resorcinol arylate polyester chain members as typically illustrated in the structural moiety of formula (III) wherein R and n are as previously defined:

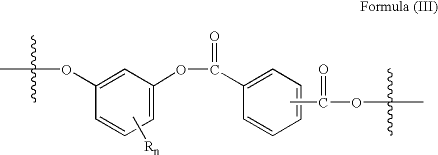

The block copolyestercarbonates of the invention are prepared by a method which comprises a first step of preparing a hydroxy-terminated polyester intermediate by an interfacial method in a reaction mixture comprising water and at least one organic solvent substantially immiscible with water. Through careful control of the reaction parameters during the interfacial preparation of the hydroxy-terminated polyester intermediates, the poor thermal stability sometimes observed in the final copolyestercarbonate may be overcome. Typically, however, control of the molecular weight of the hydroxy-terminated polyester intermediate has proven difficult to achieve. In the absence of a chain-stopper, the molecular weight of the hydroxy-terminated polyester intermediate produced interfacially is essentially uncontrolled. This is particularly true when the dihydroxy-substituted aromatic compound and its salts are highly insoluble in the solvent forming the organic phase of the interfacial reaction mixture. The present inventors have discovered that by increasing the molar ratio of the dihydroxy-substituted aromatic compound to the diacid chloride employed, and by decreasing the amount of water present in the interfacial reaction of the dihydroxy-substituted aromatic compound with the diacid chloride, enhanced control of the molecular weight of the hydroxy-terminated polyester intermediate may be achieved without the use of an endcapping agent. A failure to control the molecular weight of the hydroxy-terminated polyester intermediate limits the utility of the hydroxy-terminated polyester intermediate in the preparation of transparent, non-ghosting copolyestercarbonates because when the molecular weight of the hydroxy-terminated polyester intermediate exceeds a certain molecular weight the polycarbonate and polyester elements of the copolyestercarbonate tend to phase separate to such a degree that haze and/or ghosting is observed in films and molded parts prepared from such copolyestercarbonates. The onset of haze or ghosting is also related to the relative amounts of the polyester and polycarbonate components of the copolyestercarbonate. Thus, the threshold molecular weight of the hydroxy-terminated polyester intermediate at which haze and ghosting appears in the copolyestercarbonate is also dependent upon the relative amounts of polyester and polycarbonate components of said copolyestercarbonate. It has been discovered that haze and ghosting for a wide variety of copolyestercarbonate compositions having varying levels of polyester and polycarbonate components may be minimized by controlling the molecular weight of the hydroxy-terminated polyester intermediate using the method of the present invention.

Restriction of the amount of water present in the interfacial reaction of the dihydroxy-substituted aromatic compound with the diacid chloride is critical to achieving adequate control of the molecular weight of the hydroxy-terminated polyester intermediate. Throughout this description of the invention and in the claims which follow, the limitation on the amount of water present during the interfacial preparation of the hydroxy-terminated polyester intermediate is expressed for reasons of convenience in terms of “% Salts”. The term “% Salts” refers to the “final salt level” and references the theoretical amount of salt formed in the interfacial preparation of the hydroxy-terminated polyester intermediate expressed as a concentration in an amount of water corresponding to the amount of water initially charged to the interfacial reaction plus the amount of water added as aqueous base. It should be noted that the term “% Salts” as used herein does not include that amount of water formed during the reaction.

To further clarify the meaning intended for the term “% Salts” a sample calculation is given below. The values are taken from Comparative Example 1 of this application.

Sample Calculation of “% Salts” or “Final Salt Level”

### Theortical amount of salt formed:

0.228 moles total diacid chloride(DAC)*2 moles=NaCl formed per mole DAC reacted=0.456 moles NaCl formed during preparation of the hydroxy-terminated polyester intermediate
0.456 moles NaCl*58.5 g/mol=26.68 g NaCl

### Water

44 g water initially charged to reactor

0.228*2=0.456 moles NaOH required for stoichiometry with 0.228 moles DAC (1 mole NaOH per mole of —Cl)

0.456 moles NaOH*40 g/mol=18.24 g NaOH added during prepration of the of the hydroxy-terminated polyester intermediate

Since NaOH added as a 50 wt % aqueous solution, 18.24 g water added as well with NaOH during oligomerization step

thus, 44 g+18.24 g=62.24 g total water at end of oligomerization (this neglects the water formed in reaction)

### % Salts (Final Salt Level)

26.68 g NaCl/(26.68 g NaCl+62.24 g water)=0.30 weight fraction=30% salts (30% Final Salt Level)

As noted, the copolyestercarbonates of the present invention are thermally stable. A primary reason for poor thermal stability among copolyestercarbonates of the type described herein is the presence of anhydride linkages in the polyester chain segments. One particular example of an anhydride linkage is illustrated in the structural moiety of formula (IV), wherein R and n are as previously defined. Such anhydride linkages link at least two mers in a polyester chain segment and may arise through combination of two isophthalate or terephthalate moieties or mixtures thereof. Although isophthalate and/or terephthalate are shown in formula (IV), it is to be understood that anhydride linkages in copolyestercarbonates may arise through combination of any suitable similar dicarboxylic acid residues or mixtures of suitable dissimilar dicarboxylic acid residues present in a reaction mixture. Also, it is to be understood that the depiction of a resorcinol-derived moiety in formula (IV) is illustrative and that some other dihydroxy-substituted aromatic hydrocarbon moiety could be present in addition to or in place of the depicted resorcinol-derived moiety.

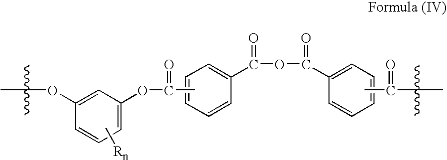

It is believed that the anhydride linkage represents a weak bond in the polyester chain, which can break under thermal processing conditions to produce shorter chains terminated by acid end-groups. These acid end-groups, in turn, may accelerate the hydrolysis of the arylate moiety, generating additional carboxyl and hydroxyl end-groups, and further contributing to the molecular weight degradation, and loss in other desirable properties. Anhydride linkages may arise through several mechanisms. In one mechanism a carboxylic acid chloride may be hydrolyzed to carboxylic acid when the esterification reaction providing the hydroxy-terminated polyester intermediate is run at high pH. The carboxylic acid or corresponding carboxylate may then react with another carboxylic acid chloride to yield an anhydride linkage.

Anhydride linkages may be detected by means known to those skilled in the art such as by ¹³C nuclear magnetic resonance spectroscopy (NMR). For example, resorcinol arylate polyesters comprising dicarboxylic acid residues derived from a mixture of iso- and terephthalic acids typically show ¹³C NM resonances attributed to anhydride at 161.0 and 161.1 ppm (in deuteriochloroform relative to tetramethylsilane), as well as resonances for the polymer carboxylic acid and hydroxyl end-groups. After thermal processing (for example, extrusion and/or molding), the polymer molecular weight decreases, and the anhydride resonances typically decrease, while those of the acid and hydroxyl end-groups typically increase.

Anhydride linkages, for example in polymers comprising resorcinol arylate polyester chain members, may also be detected by reaction of polymer with a nucleophile, such as a secondary amine. For example, a polymer sample can be dissolved in a convenient solvent, such as dichloromethane, and treated with a secondary amine, such as dibutylamine or diisobutylamine, for several minutes at ambient temperature. Comparison of the starting polymer molecular weight to that after amine treatment typically shows a decrease in molecular weight which can be correlated with the corresponding decrease observed under typical thermal processing conditions. Although the invention is not meant to be limited by theory, it is believed that nucleophiles, such as secondary amine and phenolic, attack anhydride linkages (as opposed to ester linkages) selectively under the reaction conditions. The decrease in molecular weight upon reaction with amine nucleophile is therefore an indication of the presence of anhydride functionality in the polymer.

Suitable dihydroxy-substituted aromatic hydrocarbons for preparing hydroxy-terminated polyester intermediates include those represented by the formula (V) :
HO---D---OH (V)
wherein D is a divalent aromatic radical. In some embodiments D has the structure of formula (VI); 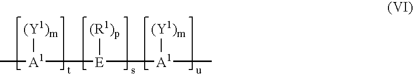
wherein A¹ represents an aromatic group such as phenylene, biphenylene, naphthylene, etc. E may be an alkylene or alkylidene group such as methylene, ethylene, ethylidene, propylene, propylidene, isopropylidene, butylene, butylidene, isobutylidene, amylene, amylidene, isoamylidene, etc. Where E is an alkylene or alkylidene group, it may also consist of two or more alkylene or alkylidene groups connected by a moiety different from alkylene or alkylidene, such as an aromatic linkage; a tertiary amino linkage; an ether linkage; a carbonyl linkage; a silicon- containing linkage; or a sulfur-containing linkage such as sulfide, sulfoxide, sulfone, etc.; or a phosphorus-containing linkage such as phosphinyl, phosphonyl, etc. In addition, E may be a cycloaliphatic group (e.g., cyclopentylidene, cyclohexylidene, 3,3,5-trimethylcyclohexylidene, methylcyclohexylidene, 2-[2.2.1]-bicycloheptylidene, neopentylidene, cyclopentadecylidene, cyclododecylidene, adamantylidene, etc.); a sulfur-containing linkage, such as sulfide, sulfoxide or sulfone; a phosphorus- containing linkage, such as phosphinyl, phosphonyl; an ether linkage; a carbonyl group; a tertiary nitrogen group; or a silicon-containing linkage such as silane or siloxy. R¹ represents hydrogen or a monovalent hydrocarbon group such as alkyl, aryl, aralkyl, alkaryl, or cycloalkyl. Y¹ may be an inorganic atom such as halogen (fluorine, bromine, chlorine, iodine); an inorganic group such as nitro; an organic group such as alkenyl, allyl, or R¹ above, or an oxy group such as OR; it being only necessary that Y¹ be inert to and unaffected by the reactants and reaction conditions used to prepare the copolyestercarbonate. The letter “m” represents any integer from and including zero through the number of positions on A¹ available for substitution; “p” represents an integer from and including zero through the number of positions on E available for substitution; “t” represents an integer equal to at least one; “s” is either zero or one; and “u” represents any integer including zero.

In the dihydroxy-substituted aromatic hydrocarbon compound in which D is represented by formula (VI) above, when more than one Y substituent is present, they may be the same or different. The same holds true for the R¹ substituent. Where “s” is zero in formula (VI) and “u” is not zero, the aromatic rings are directly joined with no intervening alkylidene or other bridge. The positions of the hydroxyl groups and Y¹ on the aromatic nuclear residues A¹ can be varied in the ortho, meta, or para positions and the groupings can be in vicinal, asymmetrical or symmetrical relationship, where two or more ring carbon atoms of the hydrocarbon residue are substituted with Y¹ and hydroxyl groups. In some particular embodiments the parameters “t”, “s”, and “u” are each one; both A¹ radicals are unsubstituted phenylene radicals; and E is an alkylidene group such as isopropylidene. In some particular embodiments both A¹ radicals are p-phenylene, although both may be o- or m-phenylene or one o- or m-phenylene and the other p-phenylene.

Some illustrative, non-limiting examples of dihydroxy-substituted aromatic hydrocarbons of formula (V) include the dihydroxy-substituted aromatic hydrocarbons disclosed by name or formula (generic or specific) in U.S. Pat. No. 4,217,438. Some particular examples of dihydroxy-substituted aromatic hydrocarbons include 4,4′-(3,3,5-trimethylcyclohexylidene)diphenol; 4,4′-bis(3,5-dimethyl)diphenol, 1,1-bis(4-hydroxy-3-methylphenyl)cyclohexane; 4,4-bis(4-hydroxyphenyl)heptane; 2,4′-dihydroxydiphenylmethane; bis(2-hydroxyphenyl)methane; bis(4-hydroxyphenyl)methane; bis(4-hydroxy-5-nitrophenyl)methane; bis(4-hydroxy-2,6-dimethyl-3-methoxyphenyl)methane; 1,1-bis(4-hydroxyphenyl)ethane; 1,1-bis(4-hydroxy-2-chlorophenyl)ethane; 2,2-bis(4-hydroxyphenyl)propane (commonly known as bisphenol A); 2,2-bis(3-phenyl-4-hydroxyphenyl)propane; 2,2-bis(4-hydroxy-3-methylphenyl)propane; 2,2-bis(4-hydroxy-3-ethylphenyl)propane; 2,2-bis(4-hydroxy-3-isopropylphenyl)propane; 2,2-bis(4-hydroxy-3,5-dimethylphenyl)propane; 3,5,3′,5′-tetrachloro-4,4′-dihydroxyphenyl)propane; bis(4-hydroxyphenyl)cyclohexylmethane; 2,2-bis(4-hydroxyphenyl)-1-phenylpropane; 2,4′-dihydroxyphenyl sulfone; 2,6-dihydroxy naphthalene; hydroquinone; resorcinol; C₁₋₃ alkyl-substituted resorcinols.

Suitable dihydroxy-substituted aromatic hydrocarbons also include those containing indane structural units such as represented by the formula (VII), which compound is 3-(4-hydroxyphenyl)-1,1,3-trimethylindan-5-ol, and by the formula (VIII), which compound is 1-(4-hydroxyphenyl)-1,3,3-trimethylindan-5-ol:

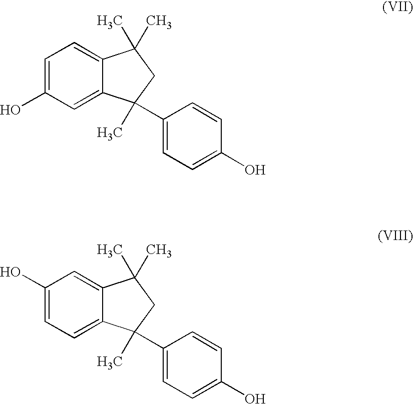

Also included among suitable dihydroxy-substituted aromatic hydrocarbons are the 2,2,2′,2′-tetrahydro-1,1′-spirobi[1H-indene]diols having formula (IX): 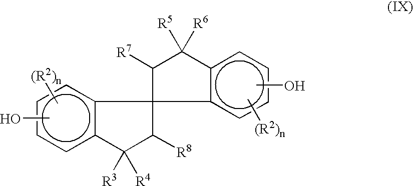
wherein each R² is independently selected from monovalent hydrocarbon radicals and halogen radicals; each R³, R⁴, R⁵, and R⁶ is independently C₁₋₆ alkyl; each R⁷ and R⁸ is independently H or C₁₋₆ alkyl; and each n is independently selected from positive integers having a value of from 0 to 3 inclusive. In a particular embodiment the 2,2,2′,2′-tetrahydro-1,1′-spirobi[1H-indene]diol is 2,2,2′,2′-tetrahydro-3,3,3′,3′-tetramethyl-1,1′-spirobi [1H-indene]-6,6′-diol (sometimes known as “SBI”).

The term “alkyl” as used in the various embodiments of the present invention is intended to designate both normal alkyl, branched alkyl, aralkyl, cycloalkyl, and bicycloalkyl radicals. In various embodiments normal and branched alkyl radicals are those containing from 1 to about 12 carbon atoms, and include as illustrative non-limiting examples methyl, ethyl, n-propyl, isopropyl, n-butyl, sec-butyl, tertiary-butyl, pentyl, neopentyl, hexyl, heptyl, octyl, nonyl, decyl, undecyl and dodecyl. In various embodiments cycloalkyl radicals are those containing from 3 to about 12 ring carbon atoms. Some illustrative non-limiting examples of these cycloalkyl radicals include cyclobutyl, cyclopentyl, cyclohexyl, methylcyclohexyl, and cycloheptyl. In various embodiments aralkyl radicals are those containing from 7 to about 14 carbon atoms; these include, but are not limited to, benzyl, phenylbutyl, phenylpropyl, and phenylethyl. In various embodiments aryl radicals used in the various embodiments of the present invention are those containing from 6 to 18 ring carbon atoms. Some illustrative non-limiting examples of these aryl radicals include phenyl, biphenyl, and naphthyl.

In the preparation of copolyestercarbonates the dihydroxy-substituted aromatic hydrocarbons described above may be used alone or as mixtures of two or more different dihydroxy-substituted aromatic hydrocarbons. In one particular embodiment a suitable dihydroxy-substituted aromatic hydrocarbon for the preparation of a copolyestercarbonate is 2,2-bis(4-hydroxyphenyl)propane (commonly known as bisphenol A or “BPA”).

In another particular embodiment the dihydroxy-substituted aromatic hydrocarbon is a resorcinol moiety. Suitable resorcinol moieties for use in the method of the invention comprise units of formula (X): 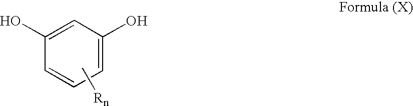
wherein R is at least one of C₁₋₁₂ alkyl or halogen, and n is 0-3. Alkyl groups, if present, are in various embodiments straight-chain, branched or cyclic alkyl groups, and are most often located in the ortho position to both oxygen atoms although other ring locations are contemplated. Suitable C₁₋₁₂ alkyl groups include, but are not limited to, methyl, ethyl, n-propyl, isopropyl, butyl, iso-butyl, t-butyl, nonyl, decyl, dodecyl and aryl-substituted alkyl, including benzyl. In a particular embodiment a suitable alkyl group is methyl. Suitable halogen groups include bromo, chloro, and fluoro. 1,3-Dihydroxybenzene moieties containing a mixture of alkyl and halogen substituents are also suitable in some embodiments. The value for n may be in one embodiment in a range of between 0 and 3, in another embodiment in a range of between 0 and 2, and in still another embodiment in a range of between 0 and 1, inclusive. In one embodiment the resorcinol moiety is 2-methylresorcinol. In another embodiment the resorcinol moiety is an unsubstituted resorcinol moiety in which n is zero. Polymers are also contemplated which contain structural units derived from mixtures of 1,3-dihydroxybenzene moieties, such as a mixture of unsubstituted resorcinol and 2-methylresorcinol.

In one embodiment when a resorcinol moiety is used, the resorcinol moiety is added to a reaction mixture as an aqueous feed solution, or feed mixture with water comprising at least some undissolved resorcinol moiety. In many circumstances aqueous feed solutions containing a resorcinol moiety such as unsubstituted resorcinol discolor with time. Although the invention is not dependent upon theory, it is believed that at least some color formation in solution may result from oxidation of resorcinol moiety species. When a discolored feed solution or feed mixture comprising resorcinol moiety is employed in synthesis of polymers of the present invention, the product polymers may be darker in color than desired, making said polymers unsuitable for use in many applications. It has been discovered that aqueous feed solutions and aqueous feed mixtures comprising a resorcinol moiety may be inhibited from discoloration by providing a pH in one embodiment of about 5 or less in the aqueous solution, in another embodiment of about 4 or less in the aqueous solution, and in still another embodiment of about 3 or less in the aqueous solution. In one embodiment when an aqueous solution comprising resorcinol moiety at a pH of about 5 or less is employed in synthesis of polymers in embodiments of the present invention, the product polymers are typically lighter in color than corresponding polymers prepared using an aqueous solution comprising resorcinol moiety without added acid. In another embodiment when an aqueous feed solution comprising resorcinol moiety at a pH of about 5 or less is employed in synthesis of polymers in embodiments of the present invention, the product polymers are typically lighter in color than corresponding polymers prepared using an aqueous solution comprising resorcinol moiety wherein the pH of the aqueous solution is greater than about 5. Color can be determined by visual observation or by other methods known to those skilled in the art, such as spectroscopic methods.

The pH of about 5 or less may be provided in some embodiments using at least one inorganic acid or at least one organic acid, or at least one of an inorganic acid in combination with at least one of an organic acid. In various embodiments inorganic acids comprise hydrochloric acid, phosphoric acid, phosphorous acid, sulfuric acid, and mixtures thereof. In various embodiments organic acids comprise organic sulfonic acids, methanesulfonic acid, p-toluenesulfonic acid, sulfonic acid- functionalized ion exchange resins, organic carboxylic acids, lactic acid, malic acid, glyceric acid, oxalic acid, malonic acid, succinic acid, glutaric acid, adipic acid, citric acid, tartaric acid, glycolic acid, thioglycolic acid, tararic acid, acetic acid, halogenated acetic acids, monochloroacetic acid, dichloroacetic acid, trichloroacetic acid, propionic acid, gluconic acid, ascorbic acid, and mixtures thereof. In some embodiments gluconic acid may be particularly beneficial because of its iron complexing ability and lack of corrosive properties compared to certain other acids.

In other embodiments an aqueous solution with a pH of 5 or less may be provided using a recycle water stream derived from washing an organic solution comprising a polymer with an aqueous solution comprising acid. In a particular embodiment the recycle water stream is derived from washing an organic solution comprising a condensation polymer and at least one salt, such as an alkali metal halide. In another particular embodiment the recycle water stream is derived from washing an organic solution comprising bisphenol A polycarbonate polymer with an aqueous acidic solution. In another particular embodiment the recycle water stream is derived from washing an organic solution comprising a resorcinol arylate-comprising polymer with an aqueous acidic solution. In another particular embodiment the recycle water stream is derived from washing an organic solution comprising a copolyestercarbonate with an aqueous acidic solution. In various embodiments suitable recycle water streams may comprise at least one alkali metal halide, such as, but not limited to, sodium chloride, sodium fluoride, potassium chloride, or potassium fluoride. In other embodiments suitable recycle water streams may comprise at least one amine salt, such as a trialkylamine hydrochloride salt. In some embodiments amine salts are derived from trialkylamines described hereinbelow. In various embodiments suitable recycle water streams comprise both of at least one alkali metal halide and at least one amine salt. In particular embodiments suitable recycle water streams comprise triethylamine hydrochloride and sodium chloride. In other embodiments suitable recycle water streams may comprise at least one amine salt which is a quaternary ammonium salt, quaternary phosphonium salt, or guanidinium salt. In some embodiments suitable quaternary ammonium salts, quaternary phosphonium salts, or guanidinium salts are those described hereinbelow. An aqueous solution comprising resorcinol moiety in recycle water has in one embodiment a pH less than or equal to about 5, in another embodiment a pH less than or equal to about 4, in another embodiment a pH less than or equal to about 3, in another embodiment a pH in a range of between about 1 and about 3, in another embodiment a pH in a range of between about 1 and about 2, and in still another embodiment a pH in a range of between about 1 and about 1.6.

In embodiments wherein the recycle water stream comprises at least one member selected from the group consisting of an amine salt, a trialkylamine hydrochloride salt, a quaternary ammonium salt, a quaternary phosphonium salt, and a guanidinium salt, then in one embodiment the recycle water stream may serve as the source of at least a portion of the total amount of these species when said species or species derived therefrom are required as catalysts in the copolyestercarbonate synthesis process. In other embodiments the recycle water stream may serve as the source of the total amount of these species when these species are required as catalysts. In a particular embodiment a recycle water stream is analyzed for the catalyst species present, and, if necessary, additional catalyst species may be added to the recycle water stream or the recycle water stream may be diluted with additional water to adjust the concentration of catalyst species so that the total amount of catalyst species added to the reaction mixture is derived from the recycle water without needing to add catalyst separately. In particular embodiments analysis and optional concentration adjustment are done before using the recycle water to prepare a solution comprising resorcinol moiety. Those skilled in the art will recognize that an aqueous composition comprising resorcinol moiety and components of a recycle water stream may be prepared and used in polymerization reactions even though said aqueous composition without resorcinol moiety was not actually used to wash an organic solution comprising a polymer.

Aqueous solutions comprising resorcinol moiety and acid or an acidic recycle water stream may be prepared before use and, if so desired, shipped to a different location and/or stored for a period of time. Said solutions may be at essentially room temperature or at a temperature above room temperature. In one embodiment solutions of a resorcinol moiety comprising water may be at a temperature above the melting point of the resorcinol moiety, for example at a temperature above the melting point of unsubstituted resorcinol.

In another embodiment a dihydroxy-substituted aromatic hydrocarbon moiety such as a resorcinol moiety may be added to a reaction vessel in a molten state as a step in the formation of a copolyestercarbonate. In a particular embodiment a molten resorcinol moiety may comprise water. In another particular embodiment a molten resorcinol moiety comprises water and at least one inorganic acid or at least one organic acid, or at least one of an inorganic acid in combination with at least one of an organic acid. In another particular embodiment a molten resorcinol moiety is essentially free of water and comprises at least one inorganic acid or at least one organic acid, or at least one of an inorganic acid in combination with at least one of an organic acid. Both types of acids may be selected from those disclosed hereinabove. In some embodiments organic acids may be selected due to their lower corrosive properties. In the present context essentially free of water means that no free water is intentionally added and the water present is that adventitiously obtained, for example through adsorption from the environment. In some embodiments essentially free of water means that a molten resorcinol moiety comprises less than about 0.5 wt % water. The amount of acid which may be present when a resorcinol moiety is added to a reaction mixture in the molten state is an amount sufficient to retard color formation over any time period compared to a corresponding composition comprising a resorcinol moiety without added acid. In various embodiments the amount of acid which may be present is in one embodiment in a range of between about 0.1 ppm and about 100,000 ppm, in another embodiment in a range of between about 1 ppm and about 10,000 ppm, in another embodiment in a range of between about 10 ppm and about 8,000 ppm, in another embodiment in a range of between about 50 ppm and about 4,000 ppm, and in still another embodiment in a range of between about 100 ppm and about 3,000 ppm.

The preparation of the hydroxy-terminated polyester intermediate according to the method of the present invention optionally comprises combining at least one catalyst with the reaction mixture. Said catalyst may be present at a total level in one embodiment in a range of between about 0.1 and about 10 mole %, and in another embodiment in a range of between about 0.2 and about 6 mole % based on total molar amount of acid chloride groups. Suitable catalysts comprise tertiary amines, quaternary ammonium salts, quaternary phosphonium salts, guanidinium salts, and mixtures thereof. Suitable tertiary amines include triethylamine, dimethylbutylamine, diisopropylethylamine, 2,2,6,6-tetramethylpiperidine, and mixtures thereof. Other contemplated tertiary amines include N-C₁-C₆-alkyl-pyrrolidines, such as N-ethylpyrrolidine, N-C₁-C₆-piperidines, such as N-ethylpiperidine, N-methylpiperidine, and N-isopropylpiperidine, N-C₁-C₆-morpholines, such as N-ethylmorpholine and N-isopropyl-morpholine, N-C₁-C₆-dihydroindoles, N-C₁-C₆-dihydroisoindoles, N-C₁-C₆-tetrahydroquinolines, N-C₁-C₆-tetrahydroisoquinolines, N-C₁-C₆-benzomorpholines, 1-azabicyclo-[3.3.0]-octane, quinuclidine, N-C₁-C₆-alkyl-2-azabicyclo-[2.2.1]-octanes, N-C₁-C₆-alkyl-2-azabicyclo-[3.3.1]-nonanes, and N-C₁-C₆-alkyl-3-azabicyclo-[3.3.1]-nonanes, N,N,N′,N′-tetraalkylalkylenediamines, including N,N,N′,N′-tetraethyl-1,6-hexanediamine. In particular embodiments tertiary amines are triethylamine and N-ethylpiperidine.

When the catalyst comprises at least one tertiary amine, then said catalyst may be present at a total level in one embodiment in a range of between about 0.1 and about 10 mole %, in another embodiment in a range of between about 0.2 and about 6 mole %, in another embodiment in a range of between about 1 and about 4 mole %, and in still another embodiment in a range of between about 2 and about 4 mole % based on total molar amount of acid chloride groups. In another particular embodiment a tertiary amine may be present at a total level in a range of between about 0.5 and about 2 mole % based on total molar amount of acid chloride groups. In one embodiment of the invention all of the at least one tertiary amine is present at the beginning of the reaction before addition of acid chloride to dihydroxy-substituted aromatic hydrocarbon moiety. In another embodiment of the invention all of the at least one tertiary amine is present at the beginning of the reaction before addition of acid chloride to a resorcinol moiety. In another embodiment a portion of any tertiary amine is present at the beginning of the reaction and a portion is added following or during addition of acid chloride to dihydroxy-substituted aromatic hydrocarbon moiety. In still another embodiment a portion of any tertiary amine is present at the beginning of the reaction and a portion is added following or during addition of acid chloride to a resorcinol moiety. In this latter embodiment the amount of any tertiary amine initially present with dihydroxy-substituted aromatic hydrocarbon moiety may range in one embodiment from about 0.005 wt.% to about 10 wt.%, in another embodiment from about 0.01 to about 1 wt.%, and in still another embodiment from about 0.02 to about 0.3 wt.% based on total amine.

Suitable quaternary ammonium salts and quaternary phosphonium salts include quaternary ammonium and quaternary phosphonium halides, illustrative examples of which include, but are not limited to, tetraethylammonium bromide, tetraethylammonium chloride, tetrapropylammonium bromide, tetrapropylammonium chloride, tetrabutylammonium bromide, tetrabutylammonium chloride, methyltributylammonium chloride, benzyltributylammonium chloride, benzyltriethylammonium chloride, benzyltrimethylammonium chloride, trioctylmethylammonium chloride, cetyldimethylbenzylammonium chloride, octyltriethylammonium bromide, decyltriethylammonium bromide, lauryltriethylammonium bromide, cetyltrimethylammonium bromide, cetyltriethylammonium bromide, N-laurylpyridinium chloride, N-laurylpyridinium bromide, N-heptylpyridinium bromide, tricaprylylmethylammonium chloride (sometimes known as ALIQUAT 336), methyltri-C₈-C₁₀-alkyl-ammonium chloride (sometimes known as ADOGEN 464), N,N,N′,N′,N′-pentaalkyl-alpha, omega-amine-ammonium salts such as disclosed in U.S. Pat. No. 5,821,322; tetrabutylphosphonium bromide, benzyltriphenylphosphonium chloride, triethyloctadecylphosphonium bromide, tetraphenylphosphonium bromide, triphenylmethylphosphonium bromide, trioctylethylphosphonium bromide, cetyltriethylphosphonium bromide. Suitable guanidinium salts include, but are not limited to, hexaalkylguanidinium salts and alpha,omega-bis(pentaalkylguanidinium)alkane salts, comprising hexaalkylguanidinium halides, alpha,omega-bis(pentaalkylguanidinium)alkane halides, hexaethylguanidinium halides, and hexaethylguanidinium chloride.

Organic solvents substantially immiscible with water suitable for use in hydroxy-terminated polyester intermediate synthesis include those which are in one embodiment less than about 5 wt. % soluble in water, and in another embodiment less than about 2 wt. % soluble in water under the reaction conditions. Suitable organic solvents include, but are not limited to, dichloromethane, trichloroethylene, tetrachloroethane, chloroform, 1,2-dichloroethane, trichloroethane, toluene, xylene, trimethylbenzene, chlorobenzene, o-dichlorobenzene, the chlorotoluenes, and mixtures thereof. In particular embodiments water-immiscible solvents are chlorinated aliphatic compounds such as dichloromethane.

Suitable acid chlorides for use in the method of the invention comprise dicarboxylic acid dichlorides which comprise aromatic dicarboxylic acid dichlorides comprising monocyclic moieties, including isophthaloyl dichloride, terephthaloyl dichloride, or mixtures of isophthaloyl and terephthaloyl dichlorides, or comprising polycyclic moieties, including diphenyl dicarboxylic acid dichloride, diphenylether dicarboxylic acid dichloride, diphenylsulfone dicarboxylic acid dichloride, diphenylketone dicarboxylic acid dichloride, diphenylsulfide dicarboxylic acid dichloride, and naphthalenedicarboxylic acid dichloride, such as naphthalene-2,6-dicarboxylic acid dichloride; or comprising mixtures of aromatic dicarboxylic acid dichlorides comprising monocyclic moieties; or mixtures of aromatic dicarboxylic acid dichlorides comprising polycyclic moieties; or mixtures of aromatic dicarboxylic acid dichlorides comprising both monocyclic and polycyclic moieties. In some embodiments the dicarboxylic acid dichloride comprises mixtures containing isophthaloyl and/or terephthaloyl dichlorides as typically illustrated in formula (XI).

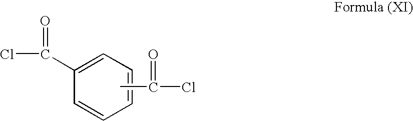

Either or both of isophthaloyl and terephthaloyl dichlorides may be present. In various embodiments the acid chlorides comprise mixtures of isophthaloyl and terephthaloyl dichloride in a molar ratio of isophthaloyl to terephthaloyl of in some embodiments about 0.25-4.0:1. When the isophthalate to terephthalate ratio is greater than about 4.0:1, then unacceptable levels of cyclic oligomer may form. When the isophthalate to terephthalate ratio is less than about 0.25:1, then unacceptable levels of insoluble polymer may form. In some embodiments the molar ratio of isophthalate to terephthalate is about 0.4-2.5:1, and in other embodiments about 0.67-1.5:1.

In another of its embodiments the present invention includes hydroxy-terminated polyester intermediates comprising resorcinol arylate polyester chain members in combination with chain members derived from dicarboxylic acid alkylene or diol alkylene chain members (so-called “soft-block” segments), said hydroxy-terminated polyester intermediates being substantially free of anhydride linkages in the polyester segments. Related polyesters containing soft-block segments are disclosed in commonly owned U.S. Pat. No. 5,916,997.

The term soft-block as used herein, indicates that some segments of these particular polymers are made from non-aromatic monomer units. Such non-aromatic monomer units are generally aliphatic and are known to impart flexibility to the soft-block-containing polymers. Such hydroxy-terminated polyester intermediates include those comprising structural units of formulas (I), (XII), and (XIII): 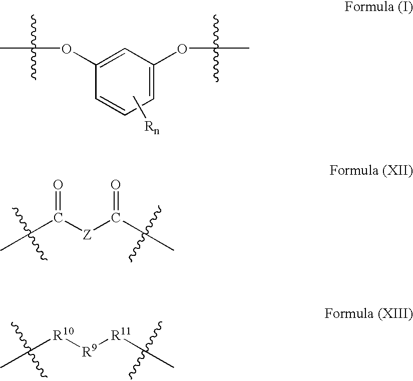
wherein R is at least one of C₁₋₁₂ alkyl or halogen, n is 0-3, Z is a divalent aromatic radical, R⁹ is a C₃₋₂₀ straight chain alkylene, C₃₋₁₀ branched alkylene, or C₄₋₁₀ cyclo- or bicycloalkylene group, and R¹⁰ and R¹¹ each independently represent 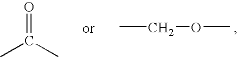
wherein formula (XIII) contributes in some embodiments from about 1 to about 45 mole percent to the ester linkages of the hydroxy-terminated polyester intermediate. Additional embodiments of the present invention provide a composition wherein formula (XIII) contributes in some embodiments from about 5 to about 40 mole percent to the ester linkages of the hydroxy-terminated polyester intermediate, and in other embodiments from about 5 to about 20 mole percent to the ester linkages of the hydroxy-terminated polyester intermediate. Other embodiments provide a composition wherein R⁹ represents C₃₋₁₄ straight chain alkylene or C₅₋₆ cycloalkylene. Still other embodiments provide a composition wherein R⁹ represents C₃₋₁₀ straight-chain alkylene or C₆-cycloalkylene. Formula (XII) represents an aromatic dicarboxylic acid residue. The divalent aromatic radical Z in formula (XII) may be derived from at least one of the suitable dicarboxylic acid residues as defined hereinabove, for example at least one of 1,3-phenylene, 1,4-phenylene, or 2,6-naphthylene. In some embodiments Z comprises at least about 40 mole percent 1,3-phenylene. In various embodiments of hydroxy-terminated polyester intermediates containing soft-block chain members n in formula (I) is zero.

In some embodiments hydroxy-terminated polyester intermediates containing resorcinol arylate chain members are those comprising from about 1 to about 45 mole % sebacate or cyclohexane-1,4-dicarboxylate units. In a particular embodiment polyester intermediates containing resorcinol arylate chain members comprise resorcinol isophthalate and resorcinol sebacate units in molar ratio between 8.5:1.5 and 9.5:0.5. In a representative procedure said hydroxy-terminated polyester intermediate is prepared using sebacoyl chloride in combination with isophthaloyl dichloride.

In various embodiments the present invention provides an interfacial method for preparing transparent, non-ghosting, thermally stable copolyestercarbonates which are substantially free of anhydride linkages, said method comprising steps of preparing a mixture comprising at least one dihydroxy-substituted aromatic hydrocarbon moiety, optionally a catalyst, and at least one organic solvent substantially immiscible with water, and water, said water being added in an amount such that the total “% Salts” (“Final Salt Level”) is greater than 30 percent; and adding to the mixture at least one acid chloride while maintaining the pH between about 3 and about 8.5, wherein the total molar amount of acid chloride groups is stoichiometrically deficient relative to the total molar amount of phenolic groups such that a molar excess of phenolic hydroxy groups to acid chloride groups is 10 percent or greater.

In another embodiment the present invention provides an interfacial method for preparing transparent, non-ghosting, thermally stable copolyestercarbonates substantially free of anhydride linkages, said method comprising steps of preparing a mixture comprising at least one dihydroxy-substituted aromatic hydrocarbon moiety, optionally one or more catalysts and at least one organic solvent substantially immiscible with water, and water, said water being added in an amount such that the total “% Salts” (“Final Salt Level”) is greater than 30 percent; and adding to the mixture at least one acid chloride and a base in some specific stoichiometric ratio of base to acid chloride that may or may not vary with time and at specific rates that may or may not vary with time, wherein the total molar amount of acid chloride groups is stoichiometrically deficient relative to the total molar amount of phenolic groups such that a molar excess of phenolic hydroxy groups to acid chloride groups is 10 percent or greater.

In the method for hydroxy-terminated polyester intermediate preparation the pH of the reaction mixture during addition of at least one acid chloride is maintained in one embodiment between about 3 and about 8.5, in another embodiment between about 4 and about 8.5, in another embodiment between about 5 and about 8.5, in another embodiment between about 5 and about 8, and in another embodiment between about 5 and about 7.5 throughout addition of the majority of the at least one acid chloride to the at least one resorcinol moiety. The pH is typically maintained through use of at least one base. Suitable bases to maintain the pH include alkali metal hydroxides, alkaline earth hydroxides, and alkaline earth oxides. In some embodiments the bases are potassium hydroxide or sodium hydroxide. In a particular embodiment the base is sodium hydroxide. The base to maintain pH may be included in the reaction mixture in any convenient form, such as solid or liquid. In a particular embodiment a base is included in the reaction mixture as an aqueous solution. In various embodiments base and acid chloride are added separately by means known in the art, including, but not limited to, one or more individual liquid addition vessels, gravimetric feeders, liquid metering pumps or metering systems, melt feed means and other known equipment.

In various embodiments at least a portion of the total amount of base is added to the reaction mixture as an aqueous solution simultaneously with acid chloride addition. In some embodiments the stoichiometric ratio of base to acid chloride is held at a substantially constant value during the addition process. Substantially constant in the present context means that any variation in ratio is adventitious. In particular embodiments the ratio of base to acid chloride during simultaneous addition is held at a constant value in a range of between about 80% and about 105% of the stoichiometric value. In other particular embodiments the ratio of base to acid chloride during simultaneous addition is held at a constant value in one embodiment in a range of between about 85% and about 105% of the stoichiometric value, in another embodiment in a range of between about 90% and about 105% of the stoichiometric value, in another embodiment in a range of between about 90% and about 100% of the stoichiometric value, and in another embodiment in a range of between about 90% and about 99% of the stoichiometric value. In other embodiments the ratio of base to acid chloride during simultaneous addition is varied during the addition process, in some embodiments in a range of between about 0% and about 1000% of the stoichiometric value, in other embodiments in a range of between about 0% and about 500% of the stoichiometric value, in other embodiments in a range of between about 0% and about 200% of the stoichiometric value, in other embodiments in a range of between about 0% and about 125% of the stoichiometric value, in other embodiments in a range of between about 0% and about 105% of the stoichiometric value, in other embodiments in a range of between about 85% and about 110% of the stoichiometric value, in other embodiments in a range of between about 90% and about 105% of the stoichiometric value, in other embodiments in a range of between about 90% and about 100% of the stoichiometric value, and in other embodiments in a range of between about 90% and about 99% of the stoichiometric value. When particularly high ratios of base to acid chloride are employed during simultaneous addition, then such a high ratio may be typically employed for a short interval, for example in some embodiments during about 0.1% to about 5% of the acid chloride addition amount. Any addition ratio far from stoichiometric is typically accounted for during the rest of the acid chloride addition. Thus, in various embodiments the average addition ratio of base to acid chloride over the entire addition of acid chloride may be in a range for example in some embodiments of between about 85% and about 105% of stoichiometric, whereas the instantaneous addition ratio may be in a much broader range. In some embodiments any remaining base not added during acid chloride addition is added following completion of acid chloride addition. In still other embodiments acid chloride addition is started before the start of base addition so that there is an initial ratio of base to acid chloride of 0%. In particular embodiments said delay time may be such that the pH remains in the desired range of in one embodiment between about 3 and about 8.5, and in another embodiment between about 5 and about 8.5. In still other embodiments base addition is stopped and then restarted at one or more points during acid chloride addition so that the stoichiometric ratio of base to acid chloride momentarily becomes 0%. In other particular embodiments the addition rates of base and of acid chloride are held at substantially constant values during the addition process. In other particular embodiments the addition rate of either base or acid chloride, or of both base and acid chloride are varied during the addition process.

In other embodiments of the invention base and acid chloride are introduced simultaneously to the reaction mixture at a substantially constant molar ratio of base to acid chloride in one embodiment for a time period of at least about 60% of total acid chloride addition, in another embodiment for at least about 70% of total acid chloride addition, in another embodiment for at least about 80% of total acid chloride addition, in another embodiment for at least about 90% of total acid chloride addition, in another embodiment for at least about 94% of total acid chloride addition, in another embodiment for at least about 98% of total acid chloride addition, in another embodiment for greater than 98% of total acid chloride addition, and in another embodiment for essentially 100% of total acid chloride addition. In other embodiments flow rates of acid chloride and of base may be varied during the acid chloride addition as long as the average molar flow rate ratio of base to acid chloride is maintained at a substantially constant value in one embodiment for a time period of at least about 60% of total acid chloride addition, in another embodiment for at least about 70% of total acid chloride addition, in another embodiment for at least about 80% of total acid chloride addition, in another embodiment for at least about 90% of total acid chloride addition, in another embodiment for at least about 94% of total acid chloride addition, in another embodiment for at least about 98% of total acid chloride addition, and in another embodiment for greater than 98% of total acid chloride addition.

In some particular embodiments base and acid chloride are added starting at a stoichiometric ratio in a range of between about 94% and 96% followed by increasing either continuously or in more than one step or in a single step the ratio to a value in a range of between about 96% and 120% during the course of the addition. In one particular embodiment the ratio is increased when the pH of the reaction mixture begins to fall below a value in a range of between about 6 and 7.5. In other particular embodiments the rate of addition of both base and of acid chloride is increased either continuously or in more than one step or in a single step during the course of addition. In other particular embodiments the rate of addition of both base and of acid chloride is decreased either continuously or in more than one step or in a single step during the course of addition. In other particular embodiments the rates of addition of base and of acid chloride are varied independently of one another. In various embodiments base may be added in sequence from more than one liquid addition vessel wherein the base is at different concentrations. In other embodiments base may be added in sequence from more than one liquid addition vessel at different rates of addition. In some embodiments depending upon such factors which include, but are not limited to, reactor configuration, stirrer geometry, stirring rate, temperature, total solvent volume, organic solvent volume, anhydride concentration, pH, the total time of addition of base and acid chloride may be less than about 120 minutes, in other embodiments in a range of between about 1 minute and about 60 minutes, in still other embodiments in a range of between about 2 minutes and about 30 minutes, and in still other embodiments in a range of between about 2 minutes and about 15 minutes.

In various embodiments of the present invention the addition of base and acid chloride in the defined ratios results in a pH of the reaction mixture in one embodiment in the range of between about 3 and about 8.5, and in another embodiment in a range of between about 5 and about 8.5. Consequently, the course of the reaction can be measured by monitoring the amount of base added in addition to or in place of monitoring the reaction by measuring pH of the reaction mixture. This is an advantage when pH must be measured accurately and instantaneously in a viscous interfacial reaction mixture which may be difficult to accomplish.

The temperature of the reaction mixture during polyester intermediate preparation may be any convenient temperature that provides a suitable reaction rate and a hydroxy-terminated polyester intermediate substantially free of anhydride linkages. Convenient temperatures include those from about 10° C. to the boiling point of the lowest boiling bulk component in the reaction mixture under the reaction conditions. The reaction may be run under pressure. In various embodiments the reactor pressure may be in the range of from about 0 pounds per square inch gauge reading (psig) to about 100 psig. In some embodiments the reaction temperature may be in a range of between ambient temperature and the boiling point of the water-organic solvent mixture under the reaction conditions. In one embodiment the reaction is performed at the boiling point of the organic solvent in the water-organic solvent mixture. In a particular embodiment the reaction is performed at the boiling point of dichloromethane.

In various embodiments the total molar amount of acid chloride groups added to the reaction mixture is stoichiometrically deficient relative to the total molar amount of phenolic groups such that the molar excess of phenolic hydroxy groups to acid chloride groups is at least about 10 percent. Said stoichiometric ratio is desirable in that it aids in limiting the molecular weight of the hydroxy-terminated polyester intermediate and may also be desirable so that hydrolysis of acid chloride groups is minimized, and so that nucleophiles such as phenolic OH groups and/or phenoxide groups may be present to destroy any adventitious anhydride linkages, should any form under the reaction conditions. The total molar amount of acid chloride groups includes at least one dicarboxylic acid dichloride, and any mono-carboxylic acid chloride chain-stoppers and any tri- or tetra-carboxylic acid tri- or tetra-chloride branching agents which may be used. The total molar amount of phenolic groups includes dihydroxy-substituted aromatic hydrocarbon moieties, and any mono-phenolic chain-stoppers and any tri- or tetra-phenolic branching agents which may be used. The stoichiometric ratio of total phenolic hydroxy groups to total acid chloride groups is in one embodiment such that phenolic hydroxy groups are present in at least about 10 mole percent excess over acid chloride groups, in another embodiment in at least about 20 mole percent excess, and in yet another embodiment in at least about 30 mole percent excess.

The presence or absence of adventitious anhydride linkages following complete addition of the at least one acid chloride to the at least one dihydroxy-substituted aromatic hydrocarbon moiety will typically depend upon the exact stoichiometric ratio of reactants and the amount of catalyst present, as well as other variables. For example, if a sufficient molar excess of total phenolic groups is present, anhydride linkages are often found to be absent. In some embodiments a molar excess of at least about 1% and in other embodiments at least about 3% of total amount of phenolic groups over total amount of acid chloride groups may suffice to eliminate anhydride linkages under the reaction conditions. When anhydride linkages may be present, it is often desirable that the final pH of the reaction mixture be in a range in one embodiment of between about 7 and about 12, in another embodiment of between about 7 and about 9, in another embodiment of between about 7.2 and about 8.8, in another embodiment of between about 7.5 and about 8.5, and in still another embodiment of between about 7.5 and about 8.3 so that nucleophiles such as phenolic, phenoxide and/or hydroxide may be present to destroy any adventitious anhydride linkages. Therefore, in some of its embodiments the method of the invention may further comprise the step of adjusting the pH of the reaction mixture in one embodiment to a value in a range of between about 7 and about 12 following complete addition of the at least one acid chloride to the at least one dihydroxy-substituted aromatic hydrocarbon moiety. The pH may be adjusted by any convenient method, for example using an aqueous base such as aqueous sodium hydroxide.

Provided the final pH of the reaction mixture is in one embodiment in a range of between about 7 and about 12 and in another embodiment in a range of between about 7 and about 9, the method of the invention in another embodiment may further comprise the step of stirring the reaction mixture for a time sufficient to destroy any adventitious anhydride linkages, should any be present. The necessary stirring time will depend upon reactor configuration, stirrer geometry, stirring rate, temperature, total solvent volume, organic solvent volume, anhydride concentration, pH, and other factors. Suitable stirring rates depend upon similar factors known to those skilled in the art and may readily be determined. In some embodiments suitable stirring rates are in a range of between about 50 rpm and about 600 rpm, in other embodiments in a range of between about 100 rpm and about 500 rpm, in other embodiments in a range of between about 200 rpm and about 500 rpm, and in still other embodiments in a range of between about 300 rpm and about 400 rpm. In some instances the necessary stirring time is essentially instantaneous, for example within seconds of pH adjustment to a value in a range of between about 7 and about 12, assuming any adventitious anhydride linkages were present to begin with. For typical laboratory scale reaction equipment a stirring time in one embodiment of at least about 1 minute, in another embodiment of at least about 3 minutes, and in another embodiment of at least about 5 minutes may be required. By this process nucleophiles, such as phenolic hydroxy groups (“phenolic OH”), phenoxide and/or hydroxide, may have time to destroy completely any adventitious anhydride linkages, should any be present.

At least one chain-stopper (also referred to sometimes hereinafter as capping agent or endcapping agent, the two terms being used interchangeably) may also be used as part of the method and compositions of the invention. One purpose of adding at least one chain-stopper is to further limit the molecular weight of the polymer, thus providing polymer with controlled molecular weight. In other embodiments at least some chain-stopper may be added when hydroxy-terminated polyester intermediate is to be either used in solution or recovered from solution for subsequent use such as in copolymer formation which may require the presence of reactive end-groups, typically phenolic hydroxy, on the polyester segments. A chain- stopper may be at least one of mono-phenolic compounds, mono-carboxylic acid chlorides, and/or mono-chloroformates. The amount of chain-stopper added at any time during the reaction may be such as to cap all or at least a portion of polymer chain end-groups. Typically, at least one chain-stopper, when present, may be present in quantities of 0.05 to 10 mole %, based on dihydroxy-substituted aromatic hydrocarbon moieties in the case of mono-phenolic compounds and based on acid dichlorides in the case mono-carboxylic acid chlorides and/or mono-chloroformates.

Suitable mono-phenolic compounds include monocyclic phenols, such as unsubstituted phenol, C₁-C₂₂ alkyl-substituted phenols, p-cumyl-phenol, p-tertiary-butyl phenol, hydroxy diphenyl; monoethers of diphenols, such as p-methoxyphenol. Alkyl-substituted phenols include those with branched chain alkyl substituents having 8 to 9 carbon atoms, in which in some embodiments about 47 to 89% of the hydrogen atoms are part of methyl groups as described in U.S. Pat. No. 4,334,053. For some embodiments a mono-phenolic UV screener is used as capping agent. Such compounds include 4-substituted-2-hydroxybenzophenones and their derivatives, aryl salicylates, monoesters of diphenols, such as resorcinol monobenzoate, 2-(2-hydroxyaryl)-benzotriazoles and their derivatives, 2-(2-hydroxyaryl)-1,3,5-triazines and their derivatives, and like compounds. In various embodiments mono-phenolic chain-stoppers are at least one of phenol, p-cumylphenol, or resorcinol monobenzoate.

Suitable mono-carboxylic acid chlorides include monocyclic, mono-carboxylic acid chlorides, such as benzoyl chloride, C₁-C₂₂ alkyl-substituted benzoyl chloride, toluoyl chloride, halogen-substituted benzoyl chloride, bromobenzoyl chloride, cinnamoyl chloride, 4-nadimidobenzoyl chloride, and mixtures thereof; polycyclic, mono-carboxylic acid chlorides, such as trimellitic anhydride chloride, and naphthoyl chloride; and mixtures of monocyclic and polycyclic mono-carboxylic acid chlorides. The chlorides of aliphatic monocarboxylic acids with up to 22 carbon atoms are also suitable. Functionalized chlorides of aliphatic monocarboxylic acids, such as acryloyl chloride and methacryoyl chloride, are also suitable. Suitable mono-chloroformates include monocyclic, mono-chloroformates, such as phenyl chloroformate, alkyl-substituted phenyl chloroformate, p-cumyl phenyl chloroformate, toluene chloroformate, and mixtures thereof.

Chain-stopper may be added to the reaction mixture in any convenient manner. In some embodiments chain-stopper can be combined together with the dihydroxy-substituted aromatic hydrocarbon moieties, can be contained in solution of acid chloride, can be added separately from acid chloride, or can be added to the reaction mixture after production of a precondensate. In some embodiments at least some of the chain-stopper is present in the reaction mixture before addition of acid chloride. In other embodiments all of the chain-stopper is present in the reaction mixture before addition of acid chloride. In some embodiments at least some of the chain-stopper is added to the reaction mixture during addition of acid chloride. In other embodiments all of the chain-stopper is added to the reaction mixture during or after addition of acid chloride. In other particular embodiments chain-stopper is added to the reaction mixture either continuously or in more than one step or in a single step during the course of acid chloride addition. In one example of continuous addition chain-stopper either in liquid or molten form is metered continuously either at a substantially constant rate or at a variable rate into the reaction mixture during the course of acid chloride addition. In one example of stepwise addition solid chain-stopper is added in portions or in a single portion to the reaction mixture during the course of acid chloride addition. If mono-carboxylic acid chlorides and/or mono-chloroformates are used as chain-stoppers, they are in some embodiments introduced mixed together with dicarboxylic acid dichlorides. These chain-stoppers can also be added to the reaction mixture at a moment when the dicarboxylic acid dichlorides have already reacted substantially or to completion. If phenolic compounds are used as chain-stoppers, they can be added to the reaction mixture in one embodiment during the reaction, or in another embodiment before the beginning of the reaction between dihydroxy-substituted aromatic hydrocarbon moiety and acid chloride moiety. When substantially hydroxy-terminated arylate-containing precondensate or oligomers are desired, then chain-stopper may be absent or only present in small amounts to aid control of oligomer molecular weight.

In another embodiment the method of the invention may encompass the inclusion of at least one branching agent such as a trifunctional or higher functional carboxylic acid chloride and/or trifunctional or higher functional phenol. Such branching agents, if included, can be used in various embodiments in quantities of 0.005 to 1 mole %, based on acid chlorides or dihydroxy-substituted aromatic hydrocarbon moieties used, respectively. Suitable branching agents include, for example, trifunctional or higher carboxylic acid chlorides, such as trimesic acid trichloride, cyanuric acid trichloride, 3,3′,4,4′-benzophenone tetracarboxylic acid tetrachloride, 1,4,5,8-naphthalene tetracarboxylic acid tetrachloride or pyromellitic acid tetrachloride, and trifunctional or higher phenols, such as phloroglucinol, 4,6-dimethyl-2,4,6-tri-(4-hydroxyphenyl)-2-heptene, 4,6-dimethyl-2,4,6-tri-(4-hydroxyphenyl)-heptane, 1,3,5-tri-(4-hydroxyphenyl)-benzene, 1,1,1-tri-(4-hydroxyphenyl)-ethane, tri-(4-hydroxyphenyl)-phenyl methane, 2,2-bis-[4,4-bis-(4-hydroxyphenyl)-cyclohexyl]-propane, 2,4-bis-(4-hydroxyphenylisopropyl)-phenol, tetra-(4-hydroxyphenyl)-methane, 2,6-bis-(2-hydroxy-5-methylbenzyl)-4-methyl phenol, 2-(4-hydroxyphenyl)-2-(2,4-dihydroxyphenyl)-propane, tetra-(4-[4-hydroxyphenylisopropyl]-phenoxy)-methane, 1,4-bis-[(4,4-dihydroxytriphenyl)methyl]-benzene. In various embodiments phenolic branching agents may be introduced first with the dihydroxy-substituted aromatic hydrocarbon moieties or during the course of acid chloride addition, whilst acid chloride branching agents may be introduced together with acid dichlorides.

If desired, the hydroxy-terminated polyester intermediate of the invention may be made by the present method further comprising the addition of a reducing agent. Suitable reducing agents include, for example, sodium sulfite, or a borohydride, such as sodium borohydride. When present, any reducing agents are typically used in quantities of from 0.25 to 2 mole %, based on moles of dihydroxy- substituted aromatic hydrocarbon moiety. The reaction mixture may also comprise a metal chelating agent such as sodium gluconate.

In some embodiments the hydroxy-terminated polyester intermediate may be recovered from the reaction mixture before copolyestercarbonate synthesis. Recovery methods are well known to those skilled in the art and may include one or more steps of acidification of the mixture, for example with at least one of an inorganic acid or an organic acid as described hereinabove; subjecting the mixture to liquid-liquid phase separation; washing the organic phase with water and/or a dilute acid such as at least one of an inorganic acid or an organic acid as described hereinabove; precipitating by usual methods such as through treatment with water or anti-solvent precipitation with, for example, an alcohol such as methanol, ethanol, and/or isopropanol; isolating the resulting precipitates; and drying to remove residual solvents. It is also contemplated, however, to proceed to a subsequent process without acidification or phase separation, and this is often possible without loss of yield or purity in the hydroxy-terminated polyester intermediate.

In another embodiment the hydroxy-terminated polyester intermediate may remain in solution for subsequent process steps. In a particular embodiment the entire interfacial reaction mixture comprising hydroxy-terminated polyester intermediate, water, and a water-immiscible organic solvent is carried on to subsequent process steps such as phosgenation to prepare block copolyestercarbonate.

The hydroxy-terminated polyester intermediates made by the present method are substantially free of anhydride linkages linking at least two mers of the polyester chain. In a particular embodiment said hydroxy-terminated polyester intermediates comprise dicarboxylic acid residues derived from a mixture of iso- and terephthalic acids and dihydroxy-substituted aromatic hydrocarbon residues derived from at least one resorcinol moiety as illustrated in formula (XIV): 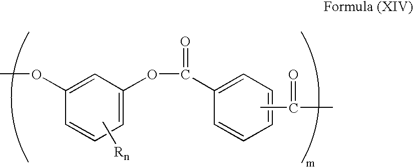
wherein R is at least one of C₁₋₁₂ alkyl or halogen, n is 0-3, and m is at least about 30. In various embodiments n is zero and m is between about 30 and about 150. The molar ratio of isophthalate to terephthalate is in one embodiment in a range of about 0.25-4.0:1, in another embodiment in a range of about 0.4-2.5:1, and in still another embodiment in a range of about 0.67-1.5:1.

In another of its embodiments the present invention comprises thermally stable block copolyestercarbonates comprising polyester block segments in combination with organic carbonate block segments. In one particular embodiment 120582-1 polyester block segments comprise resorcinol arylate-containing chain members. The segments comprising polyester chain members in such copolymers are substantially free of anhydride linkages. Substantially free of anhydride linkages means that the copolyestercarbonates show decrease in molecular weight in one embodiment of less than 10% and in another embodiment of less than 5% upon heating said copolyestercarbonate at a temperature of about 280-290° C. for five minutes.

The block copolyestercarbonates include those comprising alternating arylate and organic carbonate blocks, as illustrated in formula (XV) for a particular embodiment wherein dicarboxylic acid residues are derived from a mixture of iso- and terephthalic acids and dihydroxy-substituted aromatic hydrocarbon residues are derived from at least one resorcinol moiety, wherein R is at least one of C₁₋₁₂ alkyl or halogen, n is 0-3, and R¹² is at least one divalent organic radical:

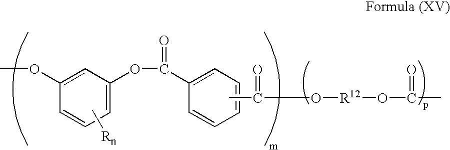

In various embodiments the arylate blocks have a degree of polymerization (DP), represented by m, in one embodiment of at least about 30, in another embodiment of at least about 50, in another embodiment of at least about 100 and in still another embodiment of about 30-150. The DP of the organic carbonate blocks, represented by p, is in one embodiment at least about 1, in another embodiment at least about 3, in another embodiment at least about 10, and in still another embodiment about 20-200. In other embodiments p has a value in a range of between about 20 and about 50. Within the context of the invention “alternating carbonate and arylate blocks” means that the copolyestercarbonates comprise at least one carbonate block and at least one arylate block. In a particular embodiment block copolyestercarbonates comprise at least one arylate block and at least two carbonate blocks. In another particular embodiment block copolyestercarbonates comprise an A-B-A architecture with at least one arylate block (“B”) and at least two carbonate blocks (“A”). In another particular embodiment block copolyestercarbonates comprise a B-A-B architecture with at least two arylate blocks (“B”) and at least one carbonate block (“A”). Mixtures of block copolyestercarbonates with different architectures are also within the scope of the invention.

In the copolyestercarbonates of the present invention the distribution of the blocks may be such as to provide a copolymer having any desired weight proportion of arylate blocks in relation to carbonate blocks. Different applications may require different weight proportion of arylate blocks in relation to carbonate blocks. In some embodiments some injection molding applications may require from 5 to 60 % by weight arylate blocks. In other embodiments some film applications may require 60 to 95 % by weight arylate blocks. The copolyestercarbonates contain in one embodiment about 10% to about 99% by weight arylate blocks; in another embodiment about 40% to about 99% by weight arylate blocks; in another embodiment about 60% to about 98% by weight arylate blocks; in another embodiment about 80% to about 96% by weight arylate blocks; and in still another embodiment about 85% to about 95% by weight arylate blocks.

Although a mixture of iso- and terephthalate is illustrated in formula (XV), the dicarboxylic acid residues in the arylate blocks may be derived from any suitable dicarboxylic acid derivative, as defined herein, or mixture of suitable dicarboxylic acid derivatives, including those derived from aliphatic diacid dichlorides (so-called “soft-block” segments). In some embodiments n is zero and the arylate blocks comprise dicarboxylic acid residues derived from a mixture of iso- and terephthalic acid residues, wherein the molar ratio of isophthalate to terephthalate is in one embodiment in a range of about 0.25-4.0:1, in another embodiment in a range of about 0.4-2.5:1, and in still another embodiment in a range of about 0.67-1.5:1.

In the organic carbonate blocks, each R¹² in formula (XV) is independently a divalent organic radical. In various embodiments said radical is derived from at least one dihydroxy-substituted aromatic hydrocarbon, and at least about 60 percent of the total number of R¹² groups in the polymer are aromatic organic radicals and the balance thereof are aliphatic, or alicyclic radicals. Suitable dihydroxy-substituted aromatic hydrocarbons include all those described hereinabove for use in the synthesis of the hydroxy-terminated polyester intermediate.

As noted, the hydroxy-terminated polyester intermediate may be isolated and purified to provide a hydroxy-terminated polyester intermediate which is essentially free of the dihydroxy-substituted aromatic compound used in its preparation. Typically, however, the hydroxy-terminated polyester intermediate is used without isolation or extensive purification. Thus, because an excess of the dihydroxy-substituted aromatic compound is used in the preparation of the hydroxy-terminated polyester intermediate, free dihydroxy-substituted aromatic compound is present in the reaction mixture remaining from the synthesis of hydroxy-terminated polyester intermediate, R¹² in the carbonate blocks of formula (XV) may consist of or at least partially comprise a radical derived from at least one dihydroxy-substituted aromatic hydrocarbon used in the synthesis of hydroxy-terminated polyester intermediate. In a particular embodiment depending upon whether or not any unreacted 1,3-dihydroxybenzene moiety is present in the reaction mixture or is added to the reaction mixture subsequently, R¹² in the carbonate blocks of formula (XV) may consist of or at least partially comprise a radical derived from a 1,3-dihydroxybenzene moiety. Therefore, in one particular embodiment of the present invention the copolyestercarbonate comprises carbonate blocks with R¹² radicals derived from a dihydroxy-substituted aromatic hydrocarbon identical to at least one 1,3-dihydroxybenzene moiety in the polyarylate blocks. In another embodiment the copolyestercarbonate comprises carbonate blocks with R¹² radicals derived from a dihydroxy-substituted aromatic hydrocarbon different from any dihydroxy-substituted aromatic hydrocarbon moiety in the polyarylate blocks. In another particular embodiment the copolyestercarbonate comprises carbonate blocks with R¹² radicals derived from a dihydroxy-substituted aromatic hydrocarbon different from any 1,3-dihydroxybenzene moiety in the polyarylate blocks. In yet another embodiment the copolyestercarbonate comprises carbonate blocks containing a mixture of R¹² radicals derived from dihydroxy-substituted aromatic hydrocarbons, at least one of which is the same as and at least one of which is different from any dihydroxy-substituted aromatic hydrocarbon in the polyarylate blocks. In yet another particular embodiment the copolyestercarbonate comprises carbonate blocks containing a mixture of R¹² radicals derived from dihydroxy-substituted aromatic hydrocarbons, at least one of which is the same as and at least one of which is different from any 1,3-dihydroxybenzene moiety in the polyarylate blocks. When a mixture of R¹² radicals derived from dihydroxy-substituted aromatic hydrocarbons is present, then the molar ratio of dihydroxy compounds identical to those present in the polyarylate blocks to those dihydroxy compounds different from those present in the polyarylate blocks is typically about 1:999 to 999:1. In some particular embodiments the copolyestercarbonates comprise carbonate blocks containing a mixture of R¹² radicals derived from at least one of unsubstituted resorcinol, a substituted resorcinol, and bisphenol A. In other particular embodiments the copolyestercarbonates comprise carbonate blocks containing a mixture of R¹² radicals derived from at least two of unsubstituted resorcinol, a substituted resorcinol, and bisphenol A.

Diblock, triblock, and multiblock copolyestercarbonates are encompassed in the present invention. The chemical linkages between blocks comprising arylate chain members and blocks comprising organic carbonate chain members (as illustrated for copolyestercarbonates comprising chain members derived from a mixture of iso- and terephthalic acids and dihydroxy-substituted aromatic hydrocarbon residues derived from at least one resorcinol moiety) may comprise at least one of
(a) an ester linkage between a suitable dicarboxylic acid residue of an arylate moiety and an —O—R¹²—O— moiety of an organic carbonate moiety, for example as illustrated in formula (XVI), wherein R¹² is as previously defined for formula (XV): 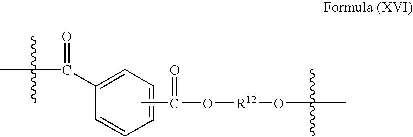
and (b) a carbonate linkage between a diphenol residue of a resorcinol arylate moiety and a —(C═O)—O— moiety of an organic carbonate moiety as shown in formula (XVII), wherein R and n are as previously defined:

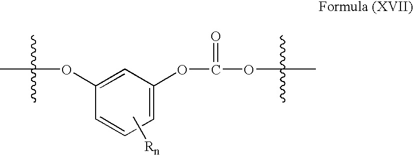

The presence of a significant proportion of ester linkages of the type (a) may result in undesirable color formation in the copolyestercarbonates. Although the invention is not limited by theory, it is believed that color may arise, for example, when R¹² in formula (XVI) is bisphenol A and the moiety of formula (XVI) undergoes Fries rearrangement during subsequent processing and/or light-exposure. In a particular embodiment the copolyestercarbonate is substantially comprised of a diblock copolymer with a carbonate linkage between an arylate block and an organic carbonate block. In another particular embodiment the copolyestercarbonate is substantially comprised of an A-B-A triblock carbonate-ester-carbonate copolymer with carbonate linkages between the arylate block and organic carbonate end-blocks. In another particular embodiment the block copolyestercarbonate is substantially comprised of a B-A-B triblock ester-carbonate-ester copolymer with carbonate linkages between the organic carbonate block and the arylate end-blocks. Mixtures of block copolyestercarbonates with different architectures linked by carbonate linkages or ester linkages, or mixtures of carbonate and ester linkages are also within the scope of the invention.

In another embodiment the copolyestercarbonate comprises arylate blocks linked by carbonate linkages, for example as shown in the representative structure of Formula (XVIII) (as illustrated for copolyestercarbonates comprising chain members derived from a mixture of iso- and terephthalic acids and dihydroxy-substituted aromatic hydrocarbon residues derived from at least one resorcinol moiety): 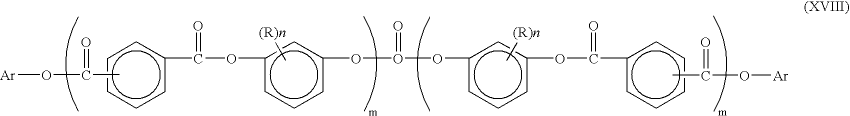
wherein R is at least one of C₁₋₁₂ alkyl or halogen, n is 0-3, Ar is an aromatic moiety, and each m independently is in one embodiment at least about 30, in another embodiment at least about 50, in another embodiment at least about 100 and in still another embodiment about 30-150. In some embodiments Ar comprises a hydroxyphenol residue derived from a dihydroxy-substituted aromatic hydrocarbon moiety (such as a 1,3-dihydroxybenzene moiety) or an aryloxycarboxyphenyl residue derived from an aromatic dicarboxylic acid diarylester. In other embodiments arylate blocks in formula (XVIII) may be terminated, for example with a mono-phenolic moiety such as a mono-phenolic chain-stopper. Copolyestercarbonates comprising formula (XVIII) may arise from reaction of hydroxy-terminated polyester intermediate with a carbonate precursor in the substantial absence of any dihydroxy compound different from the hydroxy-terminated polyester intermediate. In other embodiments the copolyestercarbonate may comprise a mixture of copolyestercarbonates with different structural units and different architectures, for example as described herein.

Copolyestercarbonates of the invention are prepared in one embodiment from hydroxy-terminated polyester intermediates prepared by methods of the invention and containing at least two hydroxy-terminal sites on each polyester chain. In some embodiments said intermediates contain at least one and often two hydroxy-terminal sites on a majority of chains. In various embodiments said intermediates may be prepared by methods of the invention wherein the molecular weight and carboxylic acid end-group concentration of the intermediate are minimized and the phenolic hydroxy end-group concentration is maximized. Said intermediates have weight average molecular weight (vs. polystyrene standards) in one embodiment of at least about 5000, in another embodiment of at least about 10000, and in still another embodiment of at least about 20000 grams per mole. In particular embodiments said hydroxy-terminated polyester intermediates have weight average molecular weights in one embodiment of about 5,000 to about 25,000, in another embodiment of about 10,000 to about 25,000, in another embodiment of about 16,000 to about 25,000, and in another embodiment of about 18,000 to about 22,000. In some embodiments said intermediates have about 300-1500 ppm carboxylic acid end- groups. In other embodiments said intermediates have about 2000-37,000 ppm phenolic hydroxy end-groups, and in still other embodiments about 2400-9700 ppm phenolic hydroxy end-groups. The hydroxy-terminated polyester intermediates have in many embodiments a higher concentration of phenolic end-groups compared to carboxylic acid end-groups. Carboxylic acid end-groups may be present, for example, through hydrolysis of acid chloride groups under the reaction conditions and as adventitious acid groups present in dicarboxylic acid dichloride starting material.

In one embodiment of the invention thermally stable copolyestercarbonates may be prepared by reacting said hydroxy-terminated polyester intermediates with a carbonate precursor, often in the presence of a catalyst. In another embodiment thermally stable copolyestercarbonates may be prepared by reacting hydroxy-terminated polyester intermediates with a carbonate precursor and at least one dihydroxy-substituted aromatic hydrocarbon, often in the presence of a catalyst. In one particular embodiment thermally stable copolyestercarbonates may be prepared by reacting a resorcinol arylate-containing polyester intermediate with a carbonate precursor and at least one dihydroxy-substituted aromatic hydrocarbon, often in the presence of a catalyst. Optionally a branching agent and/or a chain-stopper such as described hereinabove may be present in the reaction mixture.

In various embodiments the carbonate precursor is phosgene. When phosgene is employed, this synthesis step may be conducted according to art-recognized interfacial procedures (i.e., also in a two-phase system) employing a suitable interfacial polymerization catalyst and a base. The interfacial reaction procedure may comprise water and at least one organic solvent substantially immiscible with water. Suitable water immiscible solvents include those described hereinabove in the preparation of hydroxy-terminated polyester intermediates. In one embodiment a suitable water-immiscible solvent is dichloromethane. Suitable bases include those described hereinabove. In one embodiment a suitable base is aqueous sodium hydroxide. The catalyst may be of the types and species described hereinabove in the preparation of hydroxy-terminated polyester intermediates. In various embodiments a suitable catalyst may comprise a tertiary amine, typically a trialkylamine such as triethylamine or a highly nucleophilic heterocyclic amine such as 4-dimethylaminomorpholine, or a phase transfer catalyst, most often a quaternary ammonium salt such as tetrabutylammonium chloride or bromide or tetrabutylphosphonium chloride or bromide. Mixtures of such catalysts, especially mixtures of trialkylamines and tetraalkylammonium salts, may also be employed.

In various embodiments of the invention at least one dihydroxy-substituted aromatic hydrocarbon different from hydroxy-terminated polyester intermediate may optionally be present in the reaction mixture. When present, at least one dihydroxy-substituted aromatic hydrocarbon different from hydroxy-terminated polyester intermediate may be introduced into the reaction mixture for copolyestercarbonate synthesis through any convenient method of combination. In one embodiment at least one dihydroxy-substituted aromatic hydrocarbon may be present as unreacted dihydroxy-substituted aromatic hydrocarbon from the polyester synthesis. In one particular embodiment at least one dihydroxy-substituted aromatic hydrocarbon may be present as unreacted 1,3-dihydroxybenzene moiety from resorcinol arylate-containing polyester synthesis. In another embodiment at least one dihydroxy-substituted aromatic hydrocarbon may be added following polyester synthesis, before or during reaction with carbonate precursor in copolyestercarbonate synthesis. In one particular embodiment at least one dihydroxy-substituted aromatic hydrocarbon is present as unreacted 1,3-dihydroxybenzene moiety from resorcinol arylate-containing polyester synthesis and at least one dihydroxy-substituted aromatic hydrocarbon is added following polyester synthesis, before or during reaction with carbonate precursor in copolyestercarbonate synthesis. Any dihydroxy compound added following polyester synthesis, before or during reaction with carbonate precursor in copolyestercarbonate synthesis, may be the same as or different from any dihydroxy-substituted aromatic hydrocarbon moiety present initially in hydroxy-terminated polyester intermediate synthesis. In another particular embodiment the dihydroxy-substituted aromatic hydrocarbon comprises at least one of unsubstituted resorcinol or substituted resorcinol from polyester synthesis and at least one dihydroxy-substituted aromatic hydrocarbon added following polyester synthesis different from unsubstituted resorcinol or substituted resorcinol. Typically, because a molar excess of at least about 10 percent of dihydroxy-substituted aromatic hydrocarbon (relative to total moles acid chloride species present) is employed in polyester synthesis, a portion of the dihydroxy-substituted aromatic hydrocarbon remains in the product mixture comprising the hydroxy-terminated polyester intermediate. A second dihydroxy-substituted aromatic hydrocarbon may be added before or during reaction with carbonate precursor in copolyestercarbonate synthesis. In another particular embodiment a molar excess of about 10 percent or more of 1,3-dihydroxybenzene (relative to total moles acid chloride species present) is employed in the preparation of the hydroxy-terminated polyester intermediate, in which case unreacted 1,3-dihydroxybenzene remains in the product mixture comprising the hydroxy-terminated polyester intermediate. Addition of bisphenol A to this reaction mixture before or during reaction with carbonate precursor in copolyestercarbonate synthesis provides a product copolyestercarbonate having polycarbonate moieties comprising structural units derived from both resorcinol and BPA. The amount of any dihydroxy-substituted aromatic hydrocarbon moiety (such as 1,3-dihydroxybenzene moiety) remaining unreacted from polyester synthesis is in one embodiment less than about 98 mole %, in another embodiment less than about 96 mole %, in another embodiment less than about 80 mole %, in another embodiment less than about 60 mole %, in another embodiment less than about 40 mole %, in another embodiment less than about 30 mole %, in another embodiment less than about 15 mole %, in another embodiment less than about 10 mole %, and in still another embodiment less than about 5 mole % of the dihydroxy-substituted aromatic hydrocarbon moiety initially present in polyester synthesis. In another particular embodiment the amount of dihydroxy-substituted aromatic hydrocarbon moiety (such as 1,3-dihydroxybenzene moiety) remaining unreacted from polyester synthesis is less than about 2 mole % of the dihydroxy-substituted aromatic hydrocarbon moiety initially present in polyester synthesis. In another particular embodiment the amount of dihydroxy-substituted aromatic hydrocarbon moiety remaining unreacted from polyester synthesis is in a range of between about 2 mole % and about 10 mole % of the dihydroxy-substituted aromatic hydrocarbon moiety initially present in polyester synthesis.

In various embodiments when phosgene is used as carbonate precursor, then the reaction pH may optionally be adjusted to a desired value prior to phosgenation, for example to a value in a range of between about 5 and about I1. In various embodiments phosgene may be introduced to the reaction mixture at a rate of from about 0.005 mole phosgene per mole hydroxy group per minute to about 0.2 mole phosgene per mole hydroxy group per minute. Typically a target value for the total amount of phosgene added to the reaction mixture is in one embodiment in a range of between about 100% and about 300%, in another embodiment in a range of between about 110% and about 200%, in another embodiment in a range of between about 110% and about 170%, and in another embodiment in a range of between about 120% and about 150% of the stoichiometric value based on total hydroxy groups. Hydroxy groups are those in hydroxy-containing compounds which comprise hydroxy-terminated polyester intermediate and any dihydroxy-substituted or monohydroxy-substituted aromatic hydrocarbon different from hydroxy-terminated polyester intermediate that may be present in the reaction mixture. The phosgene rate of addition may be substantially constant or variable.

In various embodiments of the method of the invention base is introduced into the reaction mixture simultaneously with phosgene addition. In certain embodiments base and phosgene are introduced simultaneously to the reaction mixture at a substantially constant molar ratio of base to phosgene. This molar ratio may be in one embodiment in the range of between about 1.8 and about 2.5 mole base per mole phosgene, in another embodiment in the range of between about 1.9 and about 2.4 mole base per mole phosgene, and in still another embodiment in the range of between about 1.95 and about 2.2 mole base per mole phosgene. Each ratio represents the average molar flow rate ratio over the course of the phosgenation, wherein the molar flow rate ratio is the molar flow rate of base addition divided by the molar flow rate of phosgene addition. In other embodiments flow rates of phosgene and of base may be varied during the phosgenation as long as the average molar flow rate ratio of base to phosgene is maintained within the desired range. The average molar flow rate ratio is in one embodiment the average of the set values for molar flow rate ratios during the course of phosgene addition. In particular embodiments the average molar flow rate ratio may include molar flow rate ratios that represent inadvertent and momentary excursions outside the desired range provided the average of molar flow rate ratios is in the desired range. Thus, the proportion of base employed according to the invention is not, as in the prior art, calculated primarily to maintain an established pH set point, but rather to maintain an established molar ratio with respect to phosgene. It has been discovered that this will inherently afford a pH during the reaction within the range of about 5.5 to about 11.

In various embodiments the ratio of base to phosgene may be advantageously varied within the specified bounds as may readily be determined by experiment. In some particular embodiments the rate of addition of both base and of phosgene is increased either continuously or in more than one step or in a single step during the course of addition. In other particular embodiments the rate of addition of both base and of phosgene is decreased either continuously or in more than one step or in a single step during the course of addition. When the total amount of phosgene has been delivered, the phosgene may be shut off and, if necessary, base may be added in an amount that is sufficient to achieve a final pH target, which is in many embodiments in the range of about 5.5 to about 11.5, and in some embodiments between about 7 and about 11.

It is also within the scope of the invention to monitor the reaction pH and to adjust the molar rate ratio of base to phosgene during the course of phosgene addition in order to avoid excessively low pH excursions (for example, a pH below about 5 to 6). This may be done for safety reasons. If desired, the molar rate ratio of base to phosgene may be momentarily increased in some embodiments to a value in a range of between about 2.5 and about 4 in order to bring the reaction pH into the desired range. This is sometimes necessary, for example in a particular embodiment, after at least about one mole of phosgene per mole of bisphenol equivalent has been delivered to the reaction mixture. Conversely, if the pH exceeds a high target value (for example, a pH above about 9.5 for copolyestercarbonate phosgenation), the base ratio may be momentarily decreased to a value in the range of 0 to about 2.0. With minimal experimentation, a suitable range of base-to-phosgene ratios may be found such that it is not often necessary to deviate from a constant base-to-phosgene ratio. It is also noted that because pH electrode performance under interfacial conditions is often poor, it may often be preferable to rely on flow rate measurements rather than pH measurements for control of base addition. However, in some embodiments, it may be advantageous to employ a simple scheme wherein the pH is monitored and the base-to-phosgene ratio is adjusted based on the measured pH. For example, it is within the scope of this invention to have a system wherein the molar rate ratio of base to phosgene during phosgenation is in the range of about 1.9 to 2.4 for a measured pH in the range of 7.5-9.0, and in the range of about 2.4-4 for measured pH below 7.5, and in the range of about 0-1.9 for measured pH above 9.0. Exact ratios and pH ranges may be readily determined by experiment.

It is sometimes desirable to conduct a post-reaction phosgenation step after the initial phosgenation process is completed. Such a step may be conducted for example because the initial phosgenation reaction is judged to be incomplete based on a qualitative or quantitative analysis of a sample of the product. For example, the product may show unreacted phenolic hydroxy groups. Appropriate analytical methods, such as those for detection of unreacted hydroxy groups, are well known to those skilled in the art. Post-reaction phosgenations may be conducted under conventional pH control or under controlled ratio base addition. If controlled ratio base addition is employed, the molar ratio may be in various embodiments in the range of between about 1.8 and about 4.0 mole base per mole phosgene. The amount of phosgene added in any optional post-reaction phosgenation is in one embodiment in a range of between about 1% and about 25%, in another embodiment in a range of between about 2% and about 20% , and in another embodiment in a range of between about 5% and about 15% of the stoichiometric amount based on the hydroxyl groups initially present prior to the initial phosgenation. In some embodiments an arbitrary amount of post-reaction phosgene is added, the amount necessary to react with unreacted hydroxy groups being readily determined by experiment.

In other embodiments of the invention base and phosgene are introduced simultaneously to the reaction mixture at a substantially constant molar ratio of base to phosgene for a time period in one embodiment of at least about 60% of total phosgene addition, in another embodiment for at least about 70% of total phosgene addition, in another embodiment for at least about 80% of total phosgene addition, in another embodiment for at least about 90% of total phosgene addition, in another embodiment for at least about 94% of total phosgene addition, in another embodiment for at least about 98% of total phosgene addition, in another embodiment for greater than 98% of total phosgene addition, and in another embodiment for essentially 100% of total phosgene addition. In other embodiments flow rates of phosgene and of base may be varied during the phosgenation as long as the average molar flow rate ratio of base to phosgene is maintained at a substantially constant value for a time period in one embodiment of at least about 60% of total phosgene addition, in another embodiment of at least about 70% of total phosgene addition, in another embodiment of at least about 80% of total phosgene addition, in another embodiment of at least about 90% of total phosgene addition, in another embodiment of at least about 94% of total phosgene addition, in another embodiment of at least about 98% of total phosgene addition, and in another embodiment for greater than 98% of total phosgene addition.

The block copolyestercarbonate may be used in solution or transferred by any convenient procedure to some other solvent for use. In some embodiments the copolyestercarbonate is recovered and isolated from solution by conventional procedures. These may include, for example, at least one step selected from the group consisting of anti-solvent precipitation, washing, drying and devolatilization- pelletization or film formation via extrusion.

Block copolyestercarbonates made by the method of the present invention have in one embodiment less than about 100 ppm, in another embodiment less than about 50 ppm, and in still another embodiment less than about 20 ppm phenolic end-groups. Said copolymers contain in one embodiment less than about 50 ppm and in another embodiment less than about 25 ppm free 1,3-dihydroxybenzene moiety. The copolymers have in one embodiment less than about 2000 ppm, in another embodiment less than about 500 ppm, in another embodiment less than about 200 ppm, in another embodiment less than about 100 ppm, and in still another embodiment less than about 50 ppm carboxylic acid end-groups. In some embodiments the copolyestercarbonates have carboxylic acid end-group concentration in a range of between 0 ppm and about 100 ppm. The concentration of carboxylic acid end-groups in the copolyestercarbonates is typically less than that present in the hydroxy-terminated polyester intermediate. Carboxylic acid end-groups in said hydroxy-terminated polyester intermediate may react with carbonate precursor in the copolyestercarbonate synthesis step. For example, when phosgene is the carbonate precursor, carboxylic acid groups may react to form carboxylic acid chlorides which may then react with any phenolic groups present, for example phenolic end-groups on hydroxy-terminated polyester intermediate and any free dihydroxy-substituted aromatic hydrocarbon moiety, for example remaining from hydroxy-terminated polyester synthesis or added subsequently.

It is believed that the weatherability and certain other beneficial properties of the copolyestercarbonates of the invention are attributable, at least in part, to the occurrence of thermally or photochemically induced Fries rearrangement of arylate blocks to yield o-hydroxybenzophenone moieties or analogs thereof which serve as stabilizers to UV radiation. More particularly, at least a portion of arylate chain members can rearrange to yield chain members with at least one hydroxy group ortho to at least one ketone group. Such rearranged chain members are typically o-hydroxybenzophenone-type chain members, often comprising one or more of the following structural moieties (as illustrated for copolyestercarbonates comprising chain members derived from a mixture of iso- and terephthalic acids and dihydroxy-substituted aromatic hydrocarbon residues derived from at least one resorcinol moiety): 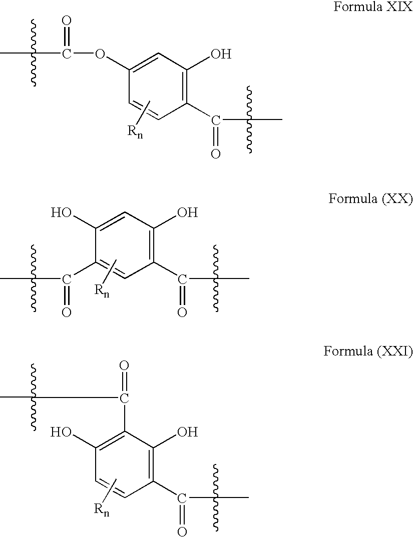
wherein R and n are as previously defined in formula (XV). It is also contemplated to introduce moieties of the types illustrated in formulas (XIX), (XX), and (XXI) via synthesis and polymerization of appropriate monomers in copolyestercarbonates made by the method of the present invention. In various particular embodiments the present invention provides non-ghosting, thermally stable copolyestercarbonates comprising structural units represented by formulas (III) and (XIX), wherein the molar ratio of structural units represented by formula (III) to structural units represented by formula (XIX) ranges in one embodiment from about 99:1 to about 1:1, and in another embodiment from about 99:1 to about 80:20.

Articles comprising a copolyestercarbonate made by the method of the invention are another embodiment of the present invention. In various embodiments articles may comprise the copolyestercarbonate, for example in admixture with additives known in the art, such as conventional UV screeners, for use for example in applications such as injection molding, thermoforming, in-mold decoration, and like applications. In other embodiments articles of the present invention are multilayer articles comprising two or more layers, typically in contiguous superposed contact with one another. In various embodiments multilayer articles comprise a substrate layer comprising at least one thermoplastic polymer, thermoset polymer, cellulosic material, glass, ceramic, or metal, and at least one coating layer thereon, said coating layer comprising a copolyestercarbonate made by the method of the invention. Optionally, the multilayer articles may further comprise an interlayer, for example an adhesive interlayer (or tie layer), between any substrate layer and any coating layer or film comprising a copolyestercarbonate made by the method of the invention. Multilayer articles of the invention include, but are not limited to, those which comprise a substrate layer and a coating layer comprising a copolyestercarbonate made by the method of the invention; those which comprise a substrate layer with a coating layer comprising said copolyestercarbonate on each side of said substrate layer; and those which comprise a substrate layer and at least one coating layer comprising a copolyestercarbonate made by the method of the invention with at least one interlayer between a substrate layer and a coating layer. Any interlayer may be transparent and/or may contain an additive, for example a colorant or decorative material such as metal flake. If desired, an overlayer may be included over the coating layer comprising a copolyestercarbonate made by the method of the invention, for example to provide abrasion or scratch resistance. In one embodiment the substrate layer, coating layer comprising a copolyestercarbonate made by the method of the invention, and any interlayers or overcoating layers are in contiguous superposed contact with one another. In any embodiment a copolyestercarbonate layer may comprise additives known in the art for use with conventional copolyestercarbonates or polycarbonates, including conventional UV screeners, heat stabilizers, flow promoters, lubricants, dyes, pigments, and the like.

Representative multilayer articles which can be made which comprise compositions of the invention include aircraft, automotive, truck, military vehicle (including automotive, aircraft, and water-borne vehicles), and motorcycle exterior and interior components, including panels, quarter panels, rocker panels, trim, fenders, doors, decklids, trunklids, hoods, bonnets, roofs, bumpers, fascia, grilles, mirror housings, pillar appliques, cladding, body side moldings, wheel covers, hubcaps, door handles, spoilers, window frames, headlamp bezels, headlamps, tail lamps, tail lamp housings, tail lamp bezels, license plate enclosures, roof racks, and running boards; enclosures, housings, panels, and parts for outdoor vehicles and devices; enclosures for electrical and telecommunication devices; outdoor furniture; boats and marine equipment, including trim, enclosures, and housings; outboard motor housings; depth finder housings, personal water-craft; jet-skis; pools; spas; hot-tubs; steps; step coverings; building and construction applications such as glazing, roofs, windows, floors, decorative window furnishings or treatments; treated glass covers for pictures, paintings, posters, and like display items; optical lenses; ophthalmic lenses; corrective ophthalmic lenses; implantable ophthalmic lenses; wall panels, and doors; protected graphics; outdoor and indoor signs; enclosures, housings, panels, and parts for automatic teller machines (ATM); enclosures, housings, panels, and parts for lawn and garden tractors, lawn mowers, and tools, including lawn and garden tools; window and door trim; sports equipment and toys; enclosures, housings, panels, and parts for snowmobiles; recreational vehicle panels and components; playground equipment; articles made from plastic-wood combinations; golf course markers; utility pit covers; computer housings; desk-top computer housings; portable computer housings; lap-top computer housings; palm-held computer housings; monitor housings; printer housings; keyboards; FAX machine housings; copier housings; telephone housings; mobile phone housings; radio sender housings; radio receiver housings; light fixtures; lighting appliances; network interface device housings; transformer housings; air conditioner housings; cladding or seating for public transportation; cladding or seating for trains, subways, or buses; meter housings; antenna housings; cladding for satellite dishes; coated helmets and personal protective equipment; coated synthetic or natural textiles; coated photographic film and photographic prints; coated painted articles; coated dyed articles; coated fluorescent articles; coated foam articles; and like applications. The invention further contemplates additional fabrication operations on said articles, such as, but not limited to, molding, in-mold decoration, baking in a paint oven, lamination, and/or thermoforming.

### EXAMPLES

The following examples are set forth to provide those of ordinary skill in the art with a detailed description of how the methods claimed herein are carried out and evaluated, and are not intended to limit the scope of what the inventors regard as their invention. Unless indicated otherwise, parts are by weight, temperature is in ° C. Molecular weights are reported as weight average (M_{w}) molecular weight in grams per mole (g/mole) and were determined by gel permeation chromatography (GPC) using polystyrene (PS) molecular weight standards.

### Comparative Examples 1-3 (10 % Excess Resorcinol, “30% Salts”)

A 1 Liter 5 neck Morton round bottom flask equipped with a mechanical stirrer, pH electrode, condenser, and two addition tubes fed by metering pumps was charged with resorcinol (27.53 g, 10% excess based on stoichiometry with diacid chloride), water (44 g, 30% salts at the end of oligomerization), methylene chloride (190 ml), triethylamine (0.46 g), and phenol (0.896 g). The mixture was stirred with a 3 inch impeller at a rate of 350 rpm. One addition tube was connected to a solution consisting of 0.114 moles (˜23.1 g) isophthaloyl chloride and 0.114 moles of terephthaloyl chloride and 65 ml of methylene chloride. The other addition tube was connected to a 50 wt % aqueous sodium hydroxide solution. Over the course of 15 minutes, the diacid chloride solution and approximately 34.6 g (95% of stoichiometry based on diacid chloride) of the NaOH solution were added at constant molar flow rates to the reactor. Upon completion of the acid chloride addition, additional 50 percent NaOH solution was added to the reactor over a period of about 4 minutes in order to adjust the pH to a range between about 7.5 and about 8.25. The mixture was then allowed to stir for and additional 6 to 8 minutes at this pH. The product hydroxy-terminated polyester (HTPE) was analyzed by gel permeation chromatography (GPC) to provide a weight average molecular weight, M_{w}, relative to polystyrene molecular weight standards. Comparative Examples 2 and 3 were carried out identically and represent replicates of Comparative Example 1. Data for the product oligomeric polyesters are given in Table 1 below.

TABLE 1
Oligomeric Polyesters Prepared Using 10% Excess Resorcinol, 30%
“Salts”, and 3.4 Mole Percent Phenol Endcap. “Iso/Tere” ratio = 1:1

| Example | Mw | RS-OH end groups (ppm)^{a} |
|---|---|---|
| Comparative Example 1 | 18991 | 3640 |
| Comparative Example 2 | 18026 | 103 |
| Comparative Example 3 | 19594 | 3517 |

^{a}Determined by ³¹P-NMR following derivatization with 1-chloro-2,5-dioxaphospholane (Aldrich)
Comparative Examples 3-10 (10-120% Excess Resorcinol, “30% Salts”)

To a 1 Liter 5 neck Morton round bottom flask equipped as in Comparative Example 1 was added resorcinol (29.18 g-58.36 g, 10-120% excess based on stoichiometry with diacid chloride), water (46 g, 30% salts at the end of oligomerization), methylene chloride (256 g), and triethylamine (0.5 g, 2 mole %). The mixture was stirred with a 3 inch impeller at a rate of 350 rpm. One addition tube was connected to a solution consisting of 0.08 moles (˜16.24 g) isophthaloyl chloride and 0.16 moles (˜32.48 g) of terephthaloyl chloride and 69ml of methylene chloride. The other addition tube was connected to a 50 wt % aqueous sodium hydroxide solution. Over the course of 15 minutes, the diacid chloride solution and approximately 36.6 g (95% of stoichiometry based on diacid chloride) of the NaOH solution were added at constant molar flow rates to the reactor. Upon completion of the acid chloride addition, a further amount of NaOH solution was added to the reactor over ˜3 minutes in order to adjust the pH to approximately 7.5-8.25, and the mixture was allowed to stir for roughly 6-8 minutes at this pH. Product hydroxy-terminated polyesters (HTPE) were analyzed as described in Comparative Example 1 and the results are given in Table 2.

TABLE 2
Oligomeric Polyesters Prepared Using 10-120% Excess Resorcinol,
“30% Salts”, and 0 Mole Percent Endcap. “Iso/Tere” ratio = 1:2

| Example | % Excess Resorcinol | M_{w} |
|---|---|---|
| Comparative Example 4 | 120.0% | 2425 |
| Comparative Example 5 | 120.0% | 2259 |
| Comparative Example 6 | 65.1% | 4383 |
| Comparative Example 7 | 39.9% | 8801 |
| Comparative Example 8 | 25.1% | 17197 |
| Comparative Example 9 | 10.0% | 44273 |
| Comparative Example 10 | 10.0% | 43175 |

Comparative Examples 3-10 were run under conditions virtually identical to Comparative Examples 1-3 with the exception that no phenol endcap was present, the ratio of isophthaloyl dichloride to terephthaloyl dichloride was 1:2, and in Comparative Examples 3-8 an amount of resorcinol greater than 10 mole percent excess based on the total number of moles of diacid chloride was employed. The data reveal the difficulty in controlling molecular weight using excess resorcinol. Thus, even reaction mixtures containing as much as 120 mole percent excess resorcinol nonetheless produced hydroxy-terminated oligomeric polyesters having significant weight average molecular weights (See Comparative Examples 4 and 5).

### Examples 1-4 and Comparative Examples 11-15 (25% Excess Resorcinol, “25-35% Salts”)

To a 1 Liter 5 neck Morton round bottom flask equipped as in Comparative Example 1 was added resorcinol (31.29 g , 25% excess based on stoichiometry with diacid chloride), water (31.2 g, 43.9 g, or 61.6 g-35%, 30%, or 25% salts at the end of oligomerization), methylene chloride (˜200 ml), and triethylamine (0.23 g, 0.46 g, or 0.69 g, 1, 2, or 3 mole %). The mixture was stirred with a 3 inch impeller at a rate of 350 rpm. One addition tube was connected to a solution consisting of 0.15 moles (˜30.6 g) isophthaloyl chloride and 0.078 moles (˜15.7 g) of terephthaloyl chloride and 65ml of methylene chloride. The other addition tube was connected to a 50 wt % aqueous sodium hydroxide solution. Over the course of 15 minutes, the diacid chloride solution and approximately 34.6 g, 32.7 g, or 30.9 g (95%, 90%, or 85% of stoichiometry based on diacid chloride) of the NaOH solution were added at constant molar flow rates to the reactor. Upon completion of the acid chloride addition, a further amount of NaOH solution was added to the reactor over ˜4 minutes in order to adjust the pH to approximately 7.5-8.25, and the mixture was allowed to stir for roughly 6-8 minutes at this pH. Product hydroxy-terminated polyesters (HTPE) were analyzed as described in Comparative Example 1 and the results are given in Table 3.

TABLE 3
Oligomeric Polyesters Prepared Using 25% Excess Resorcinol,
“25-35% Salts”, and 0 Mole Percent Endcap. “Iso/Tere” ratio = 1:1.9

| | % excess | | | | |
|---|---|---|---|---|---|
| Example | RS | % TEA | % salts | NaOH ratio (%) | Mw |
| Comparative | 25 | 3 | 25 | 95 | 32124 |
| Example 11 | | | | | |
| Example 1 | 25 | 3 | 35 | 95 | 11786 |
| Comparative | 25 | 1 | 25 | 95 | 27204 |
| Example 12 | | | | | |
| Example 2 | 25 | 1 | 35 | 95 | 18361 |
| Comparative | 25 | 1 | 25 | 85 | 20155 |
| Example 13 | | | | | |
| Example 3 | 25 | 3 | 35 | 85 | 11562 |
| Example 4 | 25 | 1 | 35 | 85 | 16795 |
| Comparative | 25 | 3 | 25 | 85 | 21428 |
| Example 14 | | | | | |
| Comparative | 25 | 2 | 30 | 90 | 17644 |
| Example 15 | | | | | |

Examples 1-4 and Comparative Examples 11-15 illustrate the surprising finding that under various reaction conditions, the value of the “% salts” has a pronounced impact on the molecular weight of the product hydroxy-tenninated polyester. Thus, under several sets of conditions where the “% salts” value is in excess of 30%, better control of the molecular weight of the product polyester is achieved.

### Examples 5-8

To a 1 Liter 5 neck Morton round bottom flask equipped as in Comparative Example 1 was added resorcinol (30.79 g, 30.29 g, 29.79 g, or 29.29 g, 23%, 21%, 19%, or 17% excess based on stoichiometry with diacid chloride), water (31.2 g, 35% salts at the end of oligomerization), methylene chloride (˜200 ml), and triethylamine (0.46 g, 2 mole %). The mixture was stirred with a 3 inch impeller at a rate of 350 rpm. One addition tube was connected to a solution consisting of 0.15 moles (˜30.6 g) isophthaloyl chloride and 0.078 moles (˜15.7 g) of terephthaloyl chloride and 65 ml of methylene chloride. The other addition tube was connected to a 50 wt % aqueous sodium hydroxide solution. Over the course of 15 minutes, the diacid chloride solution and approximately 30.9 g (85% of stoichiometry based on diacid chloride) of the NaOH solution were added at constant molar flow rates to the reactor. Upon completion of the acid chloride addition, a further amount of NaOH solution was added to the reactor over ˜4 minutes in order to adjust the pH to approximately 7.5-8.25, and the mixture was allowed to stir for roughly 6-8 minutes at this pH. Product hydroxy-terminated polyesters (HTPE) were analyzed as described in Comparative Example 1 and the results are given in Table 4.

TABLE 4
Oligomeric Polyesters Prepared Using 17-23% Excess Resorcinol (RS),
“35% Salts”, and 0 Mole Percent Endcap. “Iso/Tere” ratio = 1:1.9

| Example | % excess RS | % TEA | % salts | % NaOH ratio | MW |
|---|---|---|---|---|---|
| Example 5 | 23 | 2 | 35 | 85 | 12817 |
| Example 6 | 21 | 2 | 35 | 85 | 15927 |
| Example 7 | 19 | 2 | 35 | 85 | 18113 |
| Example 8 | 17 | 2 | 35 | 85 | 19729 |

Examples 5-8 illustrate the effect of excess resorcinol (RS) on the weight average molecular weight, M_{w}, under conditions of relatively high “% salts”. Here the amount of water employed was reduced to an amount sufficient to provide a final salt concentration of about 35% salts at the end of the reaction, the molecular weight of the polyester was effectively limited by as little as 17% excess resorcinol. Contrast Example 8 of Table 4 with Comparative Examples 1-3 of Table 1 wherein at 30% salts at 10% excess resorcinol, about 4 percent phenol endcap was required in order to limit the molecular weight of the hydroxy-terminated polyester to less than 20,000 gram per mole (g/mole). In addition, at the high % salts concentration employed in Examples 5-8 significant control of the molecular weight of the hydroxy-terminated polyester could be achieved by relatively modest increases in the amount of excess resorcinol employed.

### Examples 9-10

To a 1 Liter 5 neck Morton round bottom flask equipped as in Comparative Example 1 was added resorcinol (29.79 g, 17% excess based on stoichiometry with diacid chloride), water (33.5 g, 34% salts at the end of oligomerization), methylene chloride (˜200 ml), and triethylamine (0.46 g, 2 mole %). The mixture was stirred with a 3 inch impeller at a rate of 350 rpm. One addition tube was connected to a solution consisting of 0.114 moles (˜23.1 g) isophthaloyl chloride and 0.114 moles of terephthaloyl chloride and 65 ml of methylene chloride. The other addition tube was connected to a 50 wt % aqueous sodium hydroxide solution. Over the course of 15 minutes, the diacid chloride solution and approximately 30.9 g (85% of stoichiometry based on diacid chloride) of the NaOH solution were added at constant molar flow rates to the reactor. Upon completion of the acid chloride addition, a further amount of NaOH solution was added to the reactor over ˜4 minutes in order to adjust the pH to approximately 7.5-8.25, and the mixture was allowed to stir for roughly 6-8 minutes at this pH. Product hydroxy-terminated polyesters (HTPE) were analyzed as described in Comparative Example 1 and the results are given in Table 5.

TABLE 5
Oligomeric Polyesters Prepared Using 17% Excess Resorcinol (RS),
“34% Salts”, and 0 Mole Percent Endcap. “Iso/Tere” ratio = 1:1

| | % | | | % | | |
|---|---|---|---|---|---|---|
| | excess | % | % | NaOH | | RS-OH end |
| Example | RS | TEA | salts | ratio | M_{w} | groups (ppm) |
| Exampe 9 | 17 | 2 | 34 | 85 | 18626 | 5508 |
| Example 10 | 17 | 2 | 34 | 85 | 18760 | 5385 |

Examples 9 and 10 illustrate the performance of the method of the present invention using 17% excess resorcinol, and 34% salts in the presence of 2 mole % triethylamine (TEA) as a catalyst. Examples 9 and 10 demonstrate that significantly higher levels of polyester hydroxy end-groups (RS—OH end groups) are achieved using the method of the present invention relative to earlier processes exemplified by the Comparative Examples (Tables 1, 2 and 3). For example, although the molecular weights of the hydroxy-terminated polyesters produced in Examples 9 and 10 are roughly equivalent to the molecular weights of the hydroxy-terminated polyesters produced in Comparative Examples 1-3 the concentration of terminal hydroxy groups in the products of Examples 9 and 10 is significantly higher than the corresponding values for the products of Examples 1-3 (about 5500 ppm versus about 3500 ppm).

### Example 11-17

To a 1 Liter 5 neck Morton round bottom flask equipped as in Comparative Example 1 was added resorcinol (28.16 g, 28.79 g, 29.29 g, or 30.29 g—12.5%, 15%, 17%, or 21% excess based on stoichiometry with diacid chloride), water (33.5 g, 34% salts at the end of oligomerization), methylene chloride (˜200 ml), and triethylamine (0.69 g, 0.92 g, or 1.15 g—3, 4, or 5 mole %). The mixture was stirred with a 3 inch impeller at a rate of 350 rpm. One addition tube was connected to a solution consisting of 0.114 moles (˜23.1 g) isophthaloyl chloride and 0.114 moles of terephthaloyl chloride and 65ml of methylene chloride. The other addition tube was connected to a 50 wt % aqueous sodium hydroxide solution. Over the course of 15 minutes, the diacid chloride solution and approximately 30.9 g (85% of stoichiometry based on diacid chloride) of the NaOH solution were added at constant molar flow rates to the reactor. Upon completion of the acid chloride addition, a further amount of NaOH solution was added to the reactor over ˜4 minutes in order to adjust the pH to approximately 7.5-8.25, and the mixture was allowed to stir for roughly 6-8 minutes at this pH. Product hydroxy-terminated polyesters (HTPE) were analyzed as described in Comparative Example 1 and the results are given in Table 6.

TABLE 6
Polyesters Prepared Using 12.5-21% Excess Resorcinol (RS),
“34% Salts”, and 0 Mole Percent Endcap, and 3-5 moles % TEA.
“Iso/Tere” ratio = 1:1

| | % | | | % | | |
|---|---|---|---|---|---|---|
| | excess | % | % | NaOH | | RS-OH end |
| Example | RS | TEA | Salts | ratio | MW | groups (ppm) |
| Example 11 | 12.5 | 5 | 34 | 85 | 20550 | 4517 |
| Example 12 | 15 | 3 | 34 | 85 | 19893 | 4953 |
| Example 13 | 15 | 5 | 34 | 85 | 17124 | 4956 |
| Example 14 | 17 | 4 | 34 | 85 | 15700 | 5659 |
| Example 15 | 17 | 5 | 34 | 85 | 14741 | 6260 |
| Example 16 | 21 | 4 | 34 | 85 | 12406 | 6932 |
| Example 17 | 21 | 5 | 34 | 85 | 11493 | 8060 |

Examples 11-17 illustrate that higher levels of triethylamine ( TEA) in combination with high “% salts” can also be used to control the molecular weight of the product hydroxy-terminated polyester. Comparison of Examples 11-17 with Comparative Examples 4-10 (Table 2) illustrates the control over product hydroxy-terminated polyester molecular weight afforded by the method of the present invention relative to protocols falling outside the scope of the present invention.

### Example 18-21

To a 1 Liter 5 neck Morton round bottom flask equipped as in Comparative Example I was added resorcinol (28.54 g, 29.29 g, 30.04 g, or 31.29 g—14%, 17%, 20%, or 25% excess based on stoichiometry with diacid chloride), water (33.5 g, 34% salts at the end of oligomerization), methylene chloride (˜200 Ml), triethylamine (0.46g), and phenol endcap (1.14 g, 1.16 g, 1.19 g, or 1.22 g—for 14, 17, 20, or 25% excess RS). The amount of phenol used, 3.4 mole percent, was calculated on the total number of moles of bisphenols (resorcinol and bisphenol A) required to produce a copolyestercarbonate comprising 70 mole percent polyester repeat units and 30 mole percent polycarbonate repeat units (70/30 ITR/PC copolymer). The mixture was stirred with a 3-inch impeller at a rate of 350 rpm. One addition tube was connected to a solution consisting of 0.114 moles (˜23.1 g) isophthaloyl chloride and 0.114 moles (˜23.1 g) of terephthaloyl chloride and 65ml of methylene chloride. The other addition tube was connected to a 50-wt % aqueous sodium hydroxide solution. Over the course of 15 minutes, the diacid chloride solution and approximately 30.9 g (85% of stoichiometry based on diacid chloride) of the NaOH solution were added at constant molar flow rates to the reactor. Upon completion of the acid chloride addition, a further amount of NaOH solution was added to the reactor over ˜4 minutes in order to adjust the pH to approximately 7.5-8.25, and the mixture was allowed to stir for roughly 6-8 minutes at this pH. Product hydroxy-terminated polyesters (HTPE) were analyzed as described in Comparative Example 1 and the results are given in Table 7.

TABLE 7
Polyesters Prepared Using 14-25% Excess Resorcinol (RS), “34% Salts”,
and 3.4 Mole Percent Phenol Endcap. “Iso/Tere” ratio = 1:1

| | % | | | | | |
|---|---|---|---|---|---|---|
| | excess | | % | NaOH | | RS-OH end |
| Example | RS | % TEA | salts | ratio | MV | groups (ppm) |
| 18 | 14 | 2 | 34 | 85 | 14463 | 6145 |
| 19 | 17 | 2 | 34 | 85 | 13556 | 7471 |
| 20 | 20 | 2 | 34 | 85 | 11376 | 8969 |
| 21 | 25 | 2 | 34 | 85 | 9534 | 9865 |

Examples 18-21 illustrate that an endcapping agent (phenol) may be employed using the method of the present invention and that the inclusion of an endcapping agent during the preparation of the polyester results in both lower molecular weight and a dramatically higher levels of OH end-groups (RS—OH end groups).

### Examples 22-32 General Procedure, Preparation of Copolyestercarbonates

A 30 liter round bottom reactor equipped with a mechanical stirrer, pH electrode, condenser, and two addition tubes connected to metering pumps was charged with resorcinol (12.5, 15, 19, or 25 mole percent excess relative to the total moles of diacid chloride), water (to provide about 34-35% salts following preparation of the hydroxy-terminated polyester), methylene chloride (6 liters), and triethylamine (2 mole percent). The mixture was stirred with a 6-inch impeller at about 300-350 rpm. One addition tube was connected to a solution consisting of a 50/50 mixture of isophthaloyl and terephthaloyl chloride and enough methylene chloride to make an approximately 35-wt % diacid chloride solution. The other addition tube was connected to a 50-wt % aqueous sodium hydroxide solution. Over the course of 10 minutes, the diacid chloride solution (containing 3.42 moles isophthaloyl dichloride and 3.42 moles terephthaloyl dichloride) and 85-95 mole % of the NaOH solution (based on stoichiometry versus diacid chloride) were added at constant molar flow rates to the reactor. Upon completion of the acid chloride addition, a further amount of NaOH solution was added to the reactor over about 3 minutes in order to adjust the pH to approximately 8.25, and the mixture was allowed to stir for roughly 10 minutes at this pH. Product hydroxy-terminated polyesters (HTPE) were analyzed as described in Comparative Example 1 and the results are given in Table 8.

After formation of the hydroxy-terminated polyester was complete, phenol (3.4 mole % based on total bisphenols), bisphenol-A (BPA), additional water and methylene chloride were added to the mixture comprising the product the hydroxy-terminated polyester in the same reaction vessel. The amount of BPA added was based upon the formula:
moles BPA added=6.84 moles DAC*(1/ratio ITR to PC).
For example, the amount of BPA used in Example 26 was (6.84 mole*1/ (80/20)=6.84÷4=1.71 moles BPA). The “ratio ITR to PC” is given in Table 8 in the column headed “Ratio ITR/PC” and refers to the relative molar amounts of polyester repeat units and polycarbonate repeat units.

Prior to phosgenation, sufficient additional water was added to dissolve all of the salt (NaCl) present in the reaction mixture at the end of formation of the hydroxy-terminated polyester intermediate. Additional methylene chloride was introduced to provide a concentration of solids in the organic phase at the end of phosgenation in a range between about 11 and about 17 weight percent.

The mixture comprising the hydroxy-terminated polyester, free phenol, free excess resorcinol, BPA, methylene chloride, salt, and triethylamine (TEA) was then phosgenated in the same reactor used to prepare the hydroxy-terminated polyester intermediate. About 1.4 equivalents (based on the total moles of free bisphenol) of phosgene and 50 weight percent sodium hydroxide solution (50 wt % NaOH) were then introduced at a constant rate over a period of about 55 minutes while maintaining a pH of about pH 8.5 until about 60 percent of the stoichiometric amount of phosgene had been added (60% bisphenol conversion ). The pH was brought to pH 9.5 and the remaining phosgene was added. Upon completion of phosgene addition the reaction mixture was stirred for several minutes. The methylene chloride solution containing the product copolyestercarbonate was separated from the brine layer and then washed twice with 1N HCl, four times with deionized water. The volumes of the aqueous washes were roughly equal to the volume of the product polymer solution. The product was isolated by injection of steam into a well-agitated mixture of hot water and the methylene chloride solution of the product copolyestercarbonate. The product was isolated as a white powder was filtered and dried for 24 hours at 80 to 100° C. The product copolyestercarbonate was characterized by GPC (M_{w}, polystyrene molecular weight standards). The analytical results were consistent with the formation of block copolyestercarbonates. NMR indicated that the product copolyestercarbonate was fully endcapped as shown by the absence of free terminal hydroxyl groups (undetectable by NMR) and acid end-groups (undetectable by NMR).

The product copolyestercarbonate powder was extruded, stranded and cut into pellets. The pellets were dried overnight at about 105° C. and then molded into rectangular parts having dimensions of 2×3 inches by 1/8 inch. The molded parts were dried overnight 105° C. and then annealed under the following conditions; 2 hours at 135° C. and then 1 hour at 170° C. The annealing process was used to probe any tendency of the polycarbonate and polyester components of the copolyestercarbonates to phase separate and approximates the behavior of these materials over time. Thus, annealing serves as an accelerated aging test. Visual evaluation of the annealed parts was made by viewing directly through the surface of the part and viewing the part through an edge. The observation of haze or a bluish color indicated a tendency of the material to “ghost”. Although ghosting is most dramatically observed in relatively thin films, haze appearing in a molded part is also typically a reliable predictor of film ghosting.

TABLE 8
Product B-(A-B)ₙ Copolyestercarbonates Prepared Using the Method
of the present invention

| | | | | | | Haziness/ |
|---|---|---|---|---|---|---|
| | Ratio | excess | | | | ghosting |
| | ITR/ | resorcinol | (ITR/(R- | HTPE^{c} | Final | After |
| Example | BPA^{a} | (%) | BPA PC)^{b} | M_{w} | M_{w}^{d} | annealing |
| Example 22 | 70/30 | 15 | 65/7/28 | 22.3 k | 51 k | Slightly |
| | | | | | | hazy/ |
| | | | | | | borderline |
| Example 23 | 70/30 | 25 | 62/12/26 | 14.5 k | 50 k | Clear |
| Example 24 | 80/20 | 12.5 | 74/7/19 | 26.1 k | 56 k | Borderline |
| Example 25 | 80/20 | 19 | 71/11/18 | 22.5 k | 52 k | Clear |
| Example 26 | 80/20 | 25 | 69/14/17 | 15.2 k | — | Clear |

^{a}Ratio of moles of polyester repeat units to moles BPA
^{b}Calculated copolymer composition
^{c}M_{w} × 1000(g/mole) of the hydroxy-terminated polyester intermediate
^{d}M_{w} × 1000(g/mole) product copolyestercarbonate

The data presented in Table 8 reveal that the method of the present invention affords homogeneous, non-ghosting product copolyestercarbonates when sufficient control is exercised over the molecular weight of the hydroxy-terminated polyester (HTPE) intermediate. Moreover, the method of the present invention provides a broader range of compositions which are clear and non-ghosting relative to earlier methods which either fail to control the molecular weight of the hydroxy-terminated polyester intermediate or use an endcapping agent to control the molecular weight of the hydroxy-terminated polyester intermediate.

Examples 27-32 in Table 9 illustrate that homogeneous, non-ghosting compositions may be prepared by the method of the present invention, in which control over the molecular weight of the hydroxy-terminated polyester intermediate is supplemented by the use of an endcapping agent, phenol (3.4 mole percent based on total moles of bisphenols). In Comparative Examples 16-17 molecular weight control was achieved by adding an endcapping agent, phenol (3.4 mole percent based on total moles of bisphenols), to the reaction between the diacid chlorides and resorcinol, but without making use of the method of the present invention's requirement that the final salt level (% salts) be greater than 30 percent. In Examples 27-32 the final salt level (% salts) was 34 percent, whereas in Comparative Examples 16 and 17 the final salt level (% salts) was 30 percent. While the product hydroxy-terminated polyester intermediates produced were not fully “hydroxy-terminated” as are the hydroxy-terminated polyester intermediates prepared in the absence of chainstopper, it should be noted that the product polyester intermediates of Examples 27-32 and Comparative Examples 16 and 17 comprised substantial concentrations of terminal hydroxy groups, the presence of phenol chainstopper notwithstanding. As a result, the product copolyestercarbonates of Examples 27-32 and Comparative Examples 16-17 comprise block or multiblock copolymers of the type A-B-A or A-(B-A)ₙ, wherein “A” represents polyester block and “B” represents a polycarbonate block. In contrast, copolyester carbonates prepared without the use of chainstoppers (See Table 8) are block or multiblock copolymers of the type B-A-B and B-(A-B)ₙ, wherein the polycarbonate blocks (B) are grown from each end of a fully hydroxy-terminated polyester intermediate (A).

TABLE 9
Copolyestercarbonates Using Partially Phenoxy Encapped Polyester
Intermediates

| | | | | | | Haziness/ |
|---|---|---|---|---|---|---|
| | Ratio | excess | | | | ghosting |
| | ITR/ | resorcinol | (ITR/(R- | PE^{c} | Final | After |
| Example | BPA^{a} | (%) | BPA PC)^{b} | M_{w} | M_{w}^{d} | annealing |
| Comparative | 90/10 | 10 | 84/7/9 | 19.0 | 45 | Clear |
| Example 16 | | | | | | |
| Comparative | 80/20 | 10 | 75/6/19 | 19.0 | 45 | S hazy- |
| Example 17 | | | | | | Ghosting |
| Example 27 | 77/23 | 21 | 67/13/0 | 14.3 | 40.3 | Clear |
| Example 28 | 70/30 | 17 | 64/9/27 | 15.0 | 51 | Clear |
| Example 29 | 85/15 | 17 | 76/11/13 | 15.5 | 39.3 | Clear |
| Example 30 | 85/15 | 25 | 72/15/13 | 12.2 | 48 | Clear |
| Example 31 | 70/30 | 25 | 61/13/26 | 12.8 | 41 | Clear |
| Example 32 | 70/30 | 17 | 64/9/27 | 14.9 | 39.5 | Clear |

^{a}Ratio of polyester repeat units to moles BPA
^{b}Calculated copolymer composition
^{c}M_{w} × 1000(g/mole) of the polyester intermediate
^{d}M_{w} × 1000(g/mole) product copolyestercarbonate

The data in Table 9 illustrate, by way of Examples 27-32 and Comparative Examples 16 and 17, the ghosting behavior of copolyestercarbonates which contain high levels of the polyester component. Typically, where the level of polyester component is sufficiently high (>80%), the copolyestercarbonate exhibits clarity and does not “haze” or “ghost” (See Comparative Example 16). As the amount of the polyester component decreases relative to the amount of the polycarbonate component, the compositions tend to lose clarity and exhibit haziness and “ghosting” (See Comparative Example 17). Typically it is found that, for a given copolyestercarbonate composition having a tendency to haze or ghost, lowering the polyester intermediate molecular weight reduces or eliminates hazing and ghosting. Thus, Examples 27-32 prepared according to the method of the present invention are clear and non-ghosting compositions which would ordinarily exhibit ghosting behavior if the hydroxy-terminated polyester intermediate used to prepare them were of higher molecular weight (greater than about 18000 g/mole). As noted, in the Comparative Examples 16 and 17, control of the molecular weight of the hydroxy-terminated polyester intermediate was achieved primarily through the use of phenol as an endcapping agent. It should be noted that the molecular weight of the hydroxy-terminated polyester intermediate is also influenced by other reaction parameters such as the rate of diacid chloride addition, composition of the diacid chloride, mixing (e.g. agitator rpm), catalyst level (e.g. triethylamine concentration) and the like.

### Examples 33-38 Properties of “Low ITR” Content Copolyestercarbonates

The Compositions of Examples 33-38 and Comparative Examples 18-20 were prepared as described in the General Procedure used in Examples 22-32. As in the case of copolyestercarbonates comprising relatively high polyester content (more than about 50 percent by weight polyester), the molecular weight of the hydroxy-terminated polyester intermediate was found to be an important factor in controlling whether a given copolyestercarbonate exhibited clear-transparent behavior when the polyester content of the copolyestercarbonate was relatively low. For the purposes of the following discussion, “relatively low polyester content” (“Low ITR”) indicates copolyestercarbonates comprising less than about 50 percent by weight polyester repeat units. Copolyestercarbonates with similar compositions but different polyester intermediate molecular weights were prepared as described herein and compared. Typically, copolyestercarbonates comprising lower molecular weight polyester components tended to be transparent (Table 10). This behavior is illustrated by comparison of Example 33 with Comparative Example 18 and Example 34; Example 35 with Comparative Example 19; and Example 38 with Example 37 and Comparative Example 20. As in the case of copolyestercarbonates having higher polyester content, lower molecular weight of the polyester component is observed to promote transparency. It can be logically deduced that lowering the molecular weight of the polyester blocks results in lower molecular weight polycarbonate blocks, and it is believed that this “shortening of block length” contributes transparency in the product copolyestercarbonate.

Whether a given copolyestercarbonate is transparent is also dependent upon the relative amounts of the polyester and polycarbonate components present. The following trend was observed. For copolyestercarbonates comprising less than about 50 percent by weight polyester component, materials comprising less of the polyester component showed a greater tendency towards transparency. As the amount of the polyester component increased, the copolyestercarbonates displayed a greater tendency to exhibit hazing and ghosting. Three composition levels were studied; 10/90, 20/80, and 30/70, meaning copolyestercarbonates comprising 10, 20 and 30 percent by weight of the polyester component and 90, 80 and 70 percent by weight of the polycarbonate component respectively. It was found that as the polyester content increased, the material exhibited more haze than a corresponding copolyestercarbonate comprising less of the polyester component. For example, compare Example 33 with Example 35. A molded test part prepared from the copolyestercarbonate of Example 33 (10 percent by weight of the polyester component) was found to exhibit greater clarity (as evidenced by higher percent transmission and lower yellowness index values) both before and after annealing than an identical molded test part prepared from the copolyestercarbonate of Example 35, notwithstanding the slightly higher molecular weight of the hydroxy-terminated polyester intermediate used in Example 33 (13,000 g/mole). For copolyestercarbonates having similar molecular weights, compositions comprising 10% of the polyester component are typically more homogeneous and therefore display greater transparency than compositions comprising 20% of the polyester component. In fact, when clear samples containing 10, 20 and 30% of the polyester component were annealed (Examples 33, 35 and 38 respectively), only the sample made from the composition of Example 33 comprising 10% of the polyester component passed the visual transparency test. The sample made from the composition of Example 35 comprising 20% of the polyester component was found to be almost transparent. For each composition range studied it has been found that transparency could be improved by lowering the molecular weight of the polyester component. Dynamic mechanical analysis of these samples indicated that the compositions tended to display less homogeneity as the amount of the polyester component was increased, or as the molecular weight of the polyester component was increased.

TABLE 10
“Low ITR Content” Copolyestercarbonates (ITR Content less than 50 wt %)

| | | excess | | | | | | | |
|---|---|---|---|---|---|---|---|---|---|
| | Ratio | resorcinol | | PE^{b} | | Haziness/ghosting | Percent | Yellowness | |
| Example* | ITR/BPA^{a} | (%) | % Salts | M_{w} | Final M_{w}^{c} | After annealing | Transmission^{d} | Index (YI)^{e} | % Haze^{f} |
| Example 33 | 10/90 | 25 | 35% | 13.0 | 51.5 | Clear | 87.09 | 6.09 | 1.72 |
| Example 34 | 10/90 | 17 | 35% | 19.3 | 56.3 | Hazy | 78.71 | 22.32 | 5.46 |
| Comparative | 10/90 | 25 | 30% | 16.9 | 52.7 | Clear/slightly | 77.52 | 26.74 | 5.63 |
| Example 18 | | | | | | hazy | | | |
| Comparative | 20/80 | 25 | 25% | 20.9 | 55.9 | Hazy | 74.35 | 29.95 | 8.58 |
| Example 19 | | | | | | | | | |
| Example 35 | 20/80 | 35 | 35% | 11.7 | 50.0 | Clear | 85.92 | 11.34 | 1.46 |
| Example 36 | 20/80 | 21 | 35% | 14.6 | 50.5 | Clear/slightly | 75.08 | 27.16 | 8.54 |
| | | | | | | hazy | | | |
| Example 37 | 30/70 | 17 | 35% | 21.2 | 55.2 | Hazy | 69.36 | 33.96 | 16.00 |
| Example 38 | 30/70 | 25 | 35% | 15.6 | 54.0 | Clear | 86.42 | 10.42 | 1.20 |
| Comparative | 30/70 | 25 | 30% | 19.0 | 55.1 | Hazy | 72.17 | 31.73 | 11.66 |
| Example 20 | | | | | | | | | |

*All oligomerization relations to afford the hydroxy-terminated intermediate were carried out in the presence of 2 mole percent triethylamine
^{a}Ratio of polyester repeat units to moles BPA
^{b}M_{w} × 1000(g/mole) of the polyester intermediate
^{c}M_{w} × 1000(g/mole) product copolyestercarbonate
^{d}Percent Transmission measurements were made on a GRETAG MACBETH COLOR-EYE 7000A apparatus on annealed plaques
^{e}Yellowness Index measurements were carried out on a GRETAG MACBETH COLOR-EYE apparatus on annealed plaques
^{f}% Haze was measured on a GRETAG MACBETH COLOR-EYE apparatus before annealing.

### Examples 39-45 Programmed Addition of Hydroxy-Terminated Polyester Intermediate During Copolyestercarbonate Formation

Examples 39-47 were carried out as described in the General Procedure used in Examples 22-32 with the exception that in Examples 40 and 42-46 at least a portion of the hydroxy-terminated polyester intermediate (HTPI) was added to the reaction mixture during the phosgenation step. In processes described in the General Procedure used in Examples 22-32 all of the hydroxy-terminated polyester intermediate was present in the reaction vessel prior to the initiation of phosgenation. In other words, when phosgenation was initiated, all components were present in the reaction vessel. In the “programmed addition” alternative approach, only a portion of the hydroxy-terminated polyester intermediate (˜1/3) was present when phosgenation was begun (together with BPA and phenol endcap). The rest of the hydroxy-terminated polyester intermediate was then added gradually over the course of the phosgenation. Examples 39, 41 and 47 were carried out with all of the hydroxy-terminated polyester intermediate present in the reaction vessel prior to the introduction of phosgene. This is referred to as “up front” addition of the hydroxy-terminated polyester intermediate. The gradual addition of the hydroxy-terminated polyester intermediate to the phosgenation reaction was carried out either by stepwise addition (three steps, Examples 40, Table 11), or continuous addition (Examples 42-46, Table 11). In either mode, addition of the hydroxy-terminated polyester intermediate was complete when about 40-60% of the stochiometric amount of phosgene had been added. Gradual addition of the hydroxy-terminated polyester intermediate during phosgenation is believed to decrease coupling (via a carbonate linkage) of hydroxy-terminated polyester intermediate chains, thereby limiting the molecular weight of the polyester blocks in the product copolyestercarbonate. Programmed addition of the hydroxy-terminated polyester intermediate to the polymerization mixture likewise promotes the distribution of polycarbonate blocks between the polyester blocks. Moreover, the polycarbonate block length may also be controlled by the programmed addition of he hydroxy-terminated polyester intermediate during copolyestercarbonate formation. It is believed that such control over the copolyestercarbonate molecular architecture promotes enhanced compatibility (and hence greater clarity) of the polycarbonate and polyester components of the product copolyestercarbonates. The data provided in Table 11 demonstrate that programmed addition of the hydroxy-terminated polyester intermediate during phosgenation enhances the transparency of the product copolyestercarbonates. Compositions which were hazy or slightly hazy (after annealing) when prepared using an “up front” addition, exhibited greater clarity when the programmed addition technique was employed. The transparency of the product copolyestercarbonates was checked after annealing test samples prepared from them. It is believed that annealing the test samples provides a measure of a material's behavior at equilibrium, and is thus not subject to further change. Molded test samples were dried overnight under vacuum at 105° C. and then annealed at 135° C. (for 2 hours) and then at 170° C. (for one hour). In all cases the transparency of the unannealed test samples was maintained following annealing.

TABLE 11
Properties of Copolyestercarbonates Prepared Using Programmed Addition
of the Hydroxy-terminated Polyester Intermediate

| | | excess | | | | Appearance | Mode of | | |
|---|---|---|---|---|---|---|---|---|---|
| | Ratio | resorcinol | | PE^{b} | Final | After | HTPI | Percent | Yellowness |
| Example | ITR/BPA^{a} | (%) | % Salts | M_{w} | M_{w}^{c} | annealing | Addition | Haze^{d} | Index (YI)^{e} |
| Example 39 | 20/80 | 30 | 35 | 12.0 | 51.9 | slightly | “up front” | | |
| | | | | | | hazy | | | |
| Example 40 | 20/80 | 30 | 35 | 13.0 | 56.3 | clear | stepwise | | |
| Example 41 | 20/80 | 25 | 35 | 11.7 | 50.0 | slightly | “up front” | | |
| | | | | | | hazy | | | |
| Example 42 | 10/90 | 30 | 36 | 11.5 | 49.7 | Clear | “continuous” | 1.2 | 3.4 |
| Example 43 | 20/80 | 30 | 36 | 12.3 | 51.4 | Clear | “continuous” | 0.9 | 3.3 |
| Example 44 | 30/70 | 30 | 36 | 11.9 | 50.7 | Clear | “continuous” | 0.9 | 3.5 |
| Example 45 | 50/50 | 30 | 36 | 11.1 | 49.2 | Clear | “continuous” | 1.3 | 6.6 |
| Example 46 | 40/60 | 30 | 36 | 11.1 | 48.3 | Clear | “continuous” | | |
| Example 47 | 40/60 | 30 | 36 | 10.4 | 48.6 | Slightly | | | |
| | | | | | | hazy | “up front” | | |

*All oligomerization relations to afford the hydroxy-terminated intermediate were carried out in the presence of 2 mole percent triethylamine
^{a}Ratio of polyester repeat units to moles BPA
^{b}M_{w} × 1000(g/mole) of the polyester intermediate
^{c}M_{w} × 1000(g/mole) product copolyestercarbonate
^{d}Percent Haze measurements were made on a GRETAG MACBETH COLOR-EYE 7000A apparatus before annealing
^{e}Yellowness Index measurements were carried out on a GRETAG MACBETH COLOR-EYE 7000A apparatus

The data in Table 11 reveal that clear-transparent copolymers having 10/90 to 50/50 ITR/PC compositions may be prepared using the programmed addition technique. Programmed addition of the hydroxy-terminated polyester intermediate offers access to yet an even wider range of product compositions, broadens the useful range of hydroxy-terminated intermediate molecular weights, and provides yet greater access to transparent, non-ghosting copolyestercarbonate compositions.

The invention has been described in detail with particular reference to preferred embodiments thereof, but it will be understood by those skilled in the art that variations and modifications can be effected within the spirit and scope of the invention.

c1. A method of preparing a block copolyestercarbonate comprising chain members derived from at least one dihydroxy-substituted aromatic hydrocarbon moiety and at least one aromatic dicarboxylic acid moiety, said method comprising the steps of:
(a) preparing a hydroxy-terminated polyester intermediate comprising structural units derived from at least one dihydroxy-substituted aromatic hydrocarbon moiety and at least one aromatic dicarboxylic acid moiety, by reacting under interfacial conditions at least one dihydroxy-substituted aromatic compound with at least one diacid chloride, said dihydroxy-substituted aromatic compound being present in an amount corresponding to from about 10 mole percent excess to about 125 mole percent excess relative to the amount of diacid chloride, said reacting under interfacial conditions comprising an amount of water corresponding to a final salt level of greater than 30 percent; and
(b) conducting a reaction of the hydroxy-terminated polyester intermediate with phosgene in a reaction mixture comprising water, a substantially water-immiscible organic solvent, and a base.

c2. The method of claim 1 wherein at least one dihydroxy-substituted aromatic hydrocarbon moiety has the structure HO-D-OH, wherein D is a divalent aromatic radical with the structure of formula: 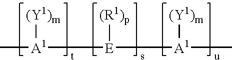
wherein A¹ is an aromatic group; E is at least one alkylene, alkylidene, or cycloaliphatic group; a sulfur-containing linkage; a phosphorus-containing linkage; an ether linkage; a carbonyl group; a tertiary nitrogen group; or a silicon-containing linkage; R¹ is hydrogen or a monovalent hydrocarbon group; Y¹ is selected independently at each occurrence from the group consisting of a monovalent hydrocarbon group, alkenyl, allyl, halogen, bromine, chlorine; nitro; and OR, wherein R is a monovalent hydrocarbon group; “m” represents any integer from and including zero through the number of positions on A¹ available for substitution; “p” represents an integer from and including zero through the number of positions on E available for substitution; “t” represents an integer equal to at least one; “s” is either zero or one; and “u” represents any integer including zero.

c3. A method according to claim 1 wherein the dihydroxy-substituted aromatic hydrocarbon moiety is at least one member selected from the group consisting of 3-(4-hydroxyphenyl)-1,1,3-trimethylindan-5-ol; 1-(4-hydroxyphenyl)- 1,3 ,3-trimethylindan-5-ol; 6,6′-dihydroxy-3 ,3,3 ′,3′-tetramethyl-1,1′-spirobiindane; 4,4′-(3,3,5-trimethylcyclohexylidene)diphenol; 4,4′-bis(3,5-dimethyl)diphenol, 1,1-bis(4-hydroxy-3-methylphenyl)cyclohexane; 4,4-bis(4-hydroxyphenyl)heptane; 2,4′-dihydroxydiphenylmethane; bis(2-hydroxyphenyl)methane; bis(4-hydroxyphenyl)methane; bis(4-hydroxy-5-nitrophenyl)methane; bis(4-hydroxy-2,6-dimethyl-3-methoxyphenyl)methane; 1,1-bis(4-hydroxyphenyl)ethane; 1,1-bis(4-hydroxy-2-chlorophenyl)ethane; 2,2-bis(4-hydroxyphenyl)propane; 2,2-bis(3-phenyl-4-hydroxyphenyl)propane; 2,2-bis(4-hydroxy-3-methylphenyl)propane; 2,2-bis(4-hydroxy-3-ethylphenyl)propane; 2,2-bis(4-hydroxy-3-isopropylphenyl)propane; 2,2-bis(4-hydroxy-3,5-dimethylphenyl)propane; 3,5,3′,5′-tetrachloro-4,4′-dihydroxyphenyl)propane; bis(4-hydroxyphenyl)cyclohexylmethane; 2,2-bis(4-hydroxyphenyl)-1-phenylpropane; 2,4′-dihydroxyphenyl sulfone; 2,6-dihydroxy naphthalene; hydroquinone; resorcinol; and C₁₋₃ alkyl-substituted resorcinols

c4. A method according to claim 1 wherein acid dichloride selected from the group consisting of isophthaloyl dichloride, terephthaloyl dichloride, naphthalene-2,6-dicarboxylic acid dichloride, and mixtures thereof.

c5. The method of claim 4 wherein the dicarboxylic acid dichloride is a mixture of isophthaloyl dichloride and terephthaloyl dichloride.

c6. The method of claim 5 wherein the ratio of isophthaloyl dichloride to terephthaloyl dichloride is about 0.25-4.0:1.

c7. The method of claim 5 wherein the ratio of isophthaloyl dichloride to terephthaloyl dichloride is about 0.67-1.5:1.

c8. The method of claim 1 wherein the base is at least one of an alkali metal hydroxide, an alkaline earth hydroxide, or an alkaline earth oxide.

c9. The method of claim 8 wherein the base is aqueous sodium hydroxide.

c10. The method of claim 1 wherein the organic solvent is selected from the group consisting of chloroform, chlorobenzene, dichloromethane, 1,2-dichloroethane, dichlorobenzene, toluene, xylene, trimethylbenzene, and mixtures thereof.

c11. The method of claim 1 wherein the reaction of hydroxy-terminated polyester intermediate with phosgene further comprises at least one catalyst selected from the group consisting of tertiary amines, quaternary ammonium salts, quaternary phosphonium salts, hexaalkylguanidinium salts, and mixtures thereof.

c12. The method of claim 11 wherein the catalyst is selected from the group consisting of triethylamine, dimethylbutylamine, N-ethylpiperidine, N-methylpiperidine, diisopropylethylamine, 2,2,6,6-tetramethylpiperidine, tetrapropylammonium bromide, tetrabutylammonium bromide, tetrabutylammonium chloride, methyltributylammonium chloride, benzyltriethylammonium chloride, cetyltrimethylammonium bromide, tetrabutylphosphonium bromide, hexaethylguanidinium chloride, and mixtures thereof.

c13. The method of claim 11 wherein the catalyst is at least one tertiary amine.

c14. The method of claim 1 wherein the reaction of hydroxy-terminated polyester intermediate with phosgene further comprises at least one dihydroxy-substituted aromatic hydrocarbon moiety different from the hydroxy-terminated polyester intermediate.

c15. The method of claim 14 wherein the dihydroxy-substituted aromatic hydrocarbon moiety is bisphenol A.

c16. The method of claim 1 wherein the reaction of the hydroxy-terminated polyester intermediate with phosgene is conducted in the presence of a mixture of dihydroxy-substituted aromatic hydrocarbon moieties, at least one of which is the same as and at least one of which is different from any dihydroxy-substituted aromatic hydrocarbon moiety employed in hydroxy-terminated polyester intermediate synthesis.

c17. The method of claim 16 wherein at least one member of the mixture of dihydroxy-substituted aromatic hydrocarbon moieties consists of bisphenol A.

c18. The method of claim 1 wherein base and phosgene are added simultaneously to the reaction mixture at a substantially constant molar ratio of base to phosgene for a time period of at least 80% of the total amount of phosgene added.

c19. The method of claim 1 wherein base and phosgene are added to the reaction mixture in a stoichiometric ratio of base to phosgene is in a range of between about 1.8 and about 2.5 mole base per mole phosgene.

c20. The method according to claim 1 wherein the dihydroxy-substituted aromatic compound being present in an amount corresponding to from about 15 mole percent excess to about 30 mole percent excess.

c21. The method of claim 1 wherein said final salt level is in a range from about 31 percent to about 40 percent.

c22. A method according to claim 1 wherein said conducting a reaction of the hydroxy-terminated polyester intermediate with phosgene comprises the programmed addition of the hydroxy-terminated polyester intermediate to a reaction mixture comprising water, a substantially water-immiscible organic solvent, at least one dihydroxy-substituted aromatic compound, and a base.

c23. A method for preparing a block copolyestercarbonate comprising chain members derived from at least one 1,3-dihydroxybenzene moiety and at least one aromatic dicarboxylic acid moiety, said method comprising the steps of:
(a) preparing a hydroxy-terminated polyester intermediate comprising structural units derived from at least one 1,3-dihydroxybenzene moiety and at least one aromatic dicarboxylic acid moiety by reacting under interfacial conditions at least one 1,3-dihydroxybenzene with at least one diacid chloride, said 1,3-dihydroxybenzene being present in an amount corresponding to from about 10 mole percent excess to about 125 mole percent excess relative to the amount of diacid chloride, said reacting under interfacial conditions comprising an amount of water corresponding to a final salt level of greater than 30 percent; and
(b) conducting a reaction of the hydroxy-terminated polyester intermediate with phosgene in a reaction mixture comprising water, a substantially water-immiscible organic solvent, at least one dihydroxy-substituted aromatic compound dihydroxy-substituted aromatic compound dihydroxy-substituted aromatic compound, and a base.

c24. The method of claim 23 wherein the 1,3-dihydroxybenzene is at least one member selected from the group consisting of compounds of the formula: 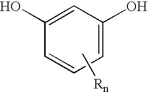
wherein R is at least one of C₁₋₁₂ alkyl or halogen, and n is 0-3.

c25. The method of claim 24 wherein the 1,3-dihydroxybenzene moiety is selected from the group consisting of unsubstituted resorcinol, 2-methyl resorcinol, and mixtures thereof.

c26. The method of claim 23 wherein the 1,3-dihydroxybenzene moiety is unsubstituted resorcinol.

c27. A method according to claim 23 wherein acid dichloride selected from the group consisting of isophthaloyl dichloride, terephthaloyl dichloride, naphthalene-2,6-dicarboxylic acid dichloride, and mixtures thereof.

c28. The method of claim 27 wherein the dicarboxylic acid dichloride is a mixture of isophthaloyl dichloride and terephthaloyl dichloride.

c29. The method of claim 28 wherein the ratio of isophthaloyl dichloride to terephthaloyl dichloride is about 0.25-4.0:1.

c30. The method of claim 28 wherein the ratio of isophthaloyl dichloride to terephthaloyl dichloride is about 0.67-1.5:1.

c31. The method of claim 28 further comprising at least one aliphatic dicarboxylic acid dichloride.

c32. The method of claim 31 wherein the aliphatic dicarboxylic acid dichloride is selected from the group consisting of sebacoyl chloride and cyclohexane-1,4-dicarboxylic acid dichloride.

c33. The method of claim 23 wherein base and phosgene are added simultaneously to the reaction mixture at a substantially constant molar ratio of base to phosgene for a time period of at least 80% of the total amount of phosgene added.

c34. The method of claim 33 wherein the stoichiometric ratio of base to phosgene is in a range of between about 1.8 and about 2.5 mole base per mole phosgene.

c35. The method of claim 34 wherein addition rates of both aqueous base and phosgene are varied during the addition process while the molar ratio is substantially constant.

c36. The method of claim 35 wherein the copolyestercarbonate is recovered from the reaction mixture.

c37. A method according to claim 1 wherein step (a) further comprises a chain-stopper.

c38. A method according to claim 1 wherein step (b) further comprises a chain-stopper.

c39. A copolyestercarbonate prepared by the method of claim 1.

c40. An article comprising the copolyestercarbonate of claim 39.

c41. A copolyestercarbonate prepared by the method of claim 23.

c42. An article comprising the copolyestercarbonate of claim 41.

c43. A hydroxy-terminated polyester intermediate prepared by the method of claim 1.

c44. A hydroxy-terminated polyester intermediate prepared by the method of claim 23.
